(19) United States
(12) Patent Application Publication
(10) Pub. No.: US 2026/0204060 A1
(43) Pub. Date: Jul. 16, 2026

(54) CONVOLUTION ACCELERATION USING CONVOLUTION KERNEL COMPRESSION BASED ON LEARNED LINEAR INDEPENDENCE

(71) Applicant: QUALCOMM Incorporated, San Diego, CA (US)

(72) Inventors: Juseong LEE, San Diego, CA (US); Sravan Kumar AMBAPURAM, Poway, CA (US); Alex Kuang-Hsuan TU, San Diego, CA (US)

(21) Appl. No.: 19/025,977

(22) Filed: Jan. 16, 2025

(51) Int. Cl. G06V 10/94; G06V 10/36; G06V 10/82

(52) U.S. Cl. CPC G06V 10/955; G06V 10/36; G06V 10/82

(57) ABSTRACT

Systems and techniques are provided for convolution kernel compression. A process can include obtaining a plurality of convolution kernels associated with a convolution-based machine learning network. Correlation information can be determined corresponding to a first and second convolution kernel portion included in the plurality of convolution kernels, the correlation information indicative of linear independence information for each respective vector of convolution weights included in the first or second convolution kernel portion. The first convolution kernel portion can be stored as a first compressed representation including a linearly independent vector of convolution weights determined based on the correlation information. The second convolution kernel portion can be stored as a second compressed representation corresponding to a linearly dependent vector of convolution weights determined based on the correlation information, the second compressed representation comprising a scalar weight value and an index associated with the linearly independent vector.

### FIELD

The present disclosure generally relates to image processing using a machine learning network. For example, aspects of the present disclosure are related to systems and techniques for performing image processing using one or more machine learning systems implementing convolution kernel compression.

### BACKGROUND

Many devices and systems allow a scene to be captured by generating images (or frames) and/or video data (including multiple frames) of the scene. For example, a camera or a device including a camera can capture a sequence of frames of a scene (e.g., a video of a scene). In some cases, the sequence of frames can be processed for performing one or more functions, can be output for display, can be output for processing and/or consumption by other devices, among other uses.

An artificial neural network attempts to replicate, using computer technology, logical reasoning performed by the biological neural networks that constitute animal brains. Deep neural networks, such as convolutional neural networks, are widely used for numerous applications, such as object detection, object classification, object tracking, big data analysis, among others. For example, convolutional neural networks are able to extract high-level features, such as facial shapes, from an input image, and use these high-level features to output a probability that, for example, an input image includes a particular object.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for image processing using a machine learning network configured to perform convolution kernel compression using learned linear independence information. According to at least one illustrative example, a method is provided, the method including: obtaining a plurality of convolution kernels associated with a convolution-based machine learning network; determining correlation information corresponding to a first convolution kernel portion and a second convolution kernel portion included in the plurality of convolution kernels, wherein the correlation information is indicative of linear independence information for each respective vector of convolution weights included in the first convolution kernel portion or the second convolution kernel portion; storing the first convolution kernel portion as a first compressed representation including a linearly independent vector of convolution weights determined based on the correlation information; and storing the second convolution kernel portion as a second compressed representation corresponding to a linearly dependent vector of convolution weights determined based on the correlation information, wherein the second compressed representation comprises a scalar weight value and an index associated with the linearly independent vector.

In another illustrative example, an apparatus for image processing using a machine learning network is provided. The apparatus includes at least one memory and at least one processor coupled to the at least one memory and configured to: obtain a plurality of convolution kernels associated with a convolution-based machine learning network; determine correlation information corresponding to a first convolution kernel portion and a second convolution kernel portion included in the plurality of convolution kernels, wherein the correlation information is indicative of linear independence information for each respective vector of convolution weights included in the first convolution kernel portion or the second convolution kernel portion; store the first convolution kernel portion as a first compressed representation including a linearly independent vector of convolution weights determined based on the correlation information; and store the second convolution kernel portion as a second compressed representation corresponding to a linearly dependent vector of convolution weights determined based on the correlation information, wherein the second compressed representation comprises a scalar weight value and an index associated with the linearly independent vector.

In another example, a non-transitory computer-readable medium is provided that includes instructions that, when executed by at least one processor, cause the at least one processor to: obtain a plurality of convolution kernels associated with a convolution-based machine learning network; determine correlation information corresponding to a first convolution kernel portion and a second convolution kernel portion included in the plurality of convolution kernels, wherein the correlation information is indicative of linear independence information for each respective vector of convolution weights included in the first convolution kernel portion or the second convolution kernel portion; store the first convolution kernel portion as a first compressed representation including a linearly independent vector of convolution weights determined based on the correlation information; and store the second convolution kernel portion as a second compressed representation corresponding to a linearly dependent vector of convolution weights determined based on the correlation information, wherein the second compressed representation comprises a scalar weight value and an index associated with the linearly independent vector.

In another example, an apparatus is provided. The apparatus includes: means for obtaining a plurality of convolution kernels associated with a convolution-based machine learning network; means for determining correlation information corresponding to a first convolution kernel portion and a second convolution kernel portion included in the plurality of convolution kernels, wherein the correlation information is indicative of linear independence information for each respective vector of convolution weights included in the first convolution kernel portion or the second convolution kernel portion; means for storing the first convolution kernel portion as a first compressed representation including a linearly independent vector of convolution weights determined based on the correlation information; and means for storing the second convolution kernel portion as a second compressed representation corresponding to a linearly dependent vector of convolution weights determined based on the correlation information, wherein the second compressed representation comprises a scalar weight value and an index associated with the linearly independent vector.

In some aspects, one or more of the apparatuses described herein is, is part of, or includes a mobile device (e.g., a mobile telephone or so-called “smart phone”, a tablet computer, or other type of mobile device), a wearable device, an extended reality (XR) device (e.g., a virtual reality (VR) device, an augmented reality (AR) device, or a mixed reality (MR) device), a vehicle (or a computing device of a vehicle), a personal computer, a laptop computer, a video server, a television (e.g., a network-connected television), or other device. In some aspects, the apparatus includes at least one camera for capturing one or more images or video frames. For example, the apparatus(es) can include a camera (e.g., a red-green-blue (RGB) camera) or multiple cameras for capturing one or more images and/or one or more videos including video frames. In some aspects, the apparatus(es) includes a display for displaying one or more images, videos, notifications, or other displayable data. In some aspects, the apparatus(es) includes at least one transmitter (or at least one transceiver) configured to transmit one or more video frame and/or syntax data over a transmission medium to at least one device. In some aspects, the at least one processor of the apparatus noted above includes a neural processing unit (NPU), a central processing unit (CPU), a digital signal processor (DSP), a graphics processing unit (GPU), or other processing device or component.

Aspects generally include a method, apparatus, system, computer program product, non-transitory computer-readable medium, user device, user equipment, wireless communication device, and/or processing system as substantially described with reference to and as illustrated by the drawings and specification.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim. The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates an example implementation of a system-on-a-chip (SOC), in accordance with some examples;

FIGS. 2A-C illustrate respective examples of a fully connected, locally connected, and convolutional neural network, in accordance with some examples;

FIG. 3 is a block diagram illustrating an example of a deep learning network, in accordance with some examples;

FIG. 4 is a block diagram illustrating an example of a convolutional neural network, in accordance with some examples;

FIG. 5 is a block diagram illustrating a deep convolutional network (DCN), in accordance with some examples;

FIG. 6 is a block diagram illustrating an example of convolution using a sliding convolution kernel, in accordance with some examples;

FIG. 7 is a diagram illustrating an example of a plurality of convolution kernels that can be used to perform convolution for an input image, in accordance with some examples;

FIG. 8 is a diagram illustrating an example of intra-kernel correlation and/or overlap associated with a plurality of convolution operations of a convolution kernel, in accordance with some examples;

FIG. 9 is a diagram illustrating an example of inter-kernel correlation and/or overlap associated with a plurality of convolution operations of a convolution kernel, in accordance with some examples;

FIG. 10 is a block diagram illustrating an example of a convolution engine that can be configured to perform convolution based on learned linear independence and computation re-use based on correlations between convolution kernels, in accordance with some examples;

FIG. 11 is a block diagram illustrating an example architecture of a convolution engine that can be implemented with a power collapsible architecture according to the convolution kernel compression and/or learned linear independence information, in accordance with some examples;

FIG. 12 is a flow chart diagram illustrating an example of a process for image processing using convolution kernel compression, in accordance with some examples;

FIG. 13 illustrates an example computing device architecture of an example computing device which can implement the various techniques described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Machine learning systems (e.g., neural network systems or models) can be used to perform a variety of tasks such as, for example and without limitation, detection and/or recognition (e.g., scene or object detection and/or recognition, face detection and/or recognition, etc.), depth estimation, pose estimation, image reconstruction, classification, three-dimensional (3D) modeling, dense regression tasks, data compression and/or decompression, and image processing, among other tasks. Moreover, machine learning models can be versatile and can achieve high quality results in a variety of tasks.

In some cases, a machine learning system can be implemented based on performing a plurality of convolution operations (e.g., using one or more convolutional layers). A convolution is an operation on two functions that produces a third function that expresses how the shape of one is modified by the other. Convolutions and/or convolutional layers can be used to process pixel data and may be implemented in various image processing and/or video processing machine learning tasks. As used herein, an “image” or “image data” may refer to a frame of pixel data having a horizontal resolution (e.g., horizontal number of pixels) and a vertical resolution (e.g., vertical number of pixels). The frame of pixel data can be associated with a still image or photograph and/or can be associated with a frame of video data.

Machine learning networks can perform convolution operations using a convolution kernel (e.g., also referred to as “filters” and/or “convolution filters”) filters that slide along a set of input features (e.g., input features arranged in a grid, matrix, vector, etc.) to generate a plurality of feature maps corresponding to the input. Convolution operations can be implemented based on the hierarchical nature of the data being processed. For example, instead of processing an entire image or input at once, a convolutional neural network (CNN) breaks the image down into smaller, simpler features, which are represented by filters (e.g., convolution kernels) that are applied to different regions of the image to extract the relevant information (e.g., corresponding feature maps for the different image regions). As the CNN progresses through its convolutional layers, the feature maps are combined and assembled into increasingly complex structures that are used to learn increasingly abstract representations of the input.

In an example CNN implementation, the input to the CNN can be a tensor with a shape given by number of inputs×input height×input width×input channels. For instance, after passing through a convolutional layer, an input image can be abstracted to a feature map (e.g., also referred to as an activation map), with a shape given by: number of inputs×input height×input width×input channels. The feature map dimensions can be smaller than the input image dimensions. Convolution layers of a machine learning network are configured to convolve the input (e.g., the input to a particular convolution layer) and pass the output result (e.g., convolved input) to the next layer of the machine learning network. A convolution layer can be implemented using a plurality of convolutional neurons. Each convolutional neuron processes data only for its receptive field. In some aspects, convolution can be performed to reduce the number of free parameters in a machine learning network (e.g., by reducing the number of free parameters, the machine learning network can be deeper for the same given network size, etc.).

A convolution kernel can be implemented as a matrix of weights that slides over the input data provided to a CNN. For example, a 3×3 convolution kernel can be a 3×3 matrix of weights that slides over the input data, processing a respective 3×3 portion of the input data for each different position of the sliding convolution kernel. For example, the 3×3 convolution kernel can be used to process an image based on sliding across the rows of pixels included in the image. At each step, the 3×3 convolution kernel can process three columns of pixels in three different rows (e.g., three columns and three rows corresponding to the size or dimension of the 3×3 convolution kernel). In each position of the 3×3 convolution kernel sliding across the input image, the convolution kernel weight values are used to perform an elementwise multiplication with the respective pixels of image data that are within the 3×3 window of the convolution kernel at the current position. The results of the elementwise multiplication are summed into a single output value for the current sliding window of the convolution. The convolution kernel can then repeat the process above for every location or position within the input image that the convolution kernel slides over, converting a 2D matrix of a first size into a 2D matrix of a second, smaller size.

Convolution operations can be used to implement various machine learning operations, which can include 2D convolutions, 3D convolutions, depth-wise convolution, group convolution, trans-convolution (e.g., transposed convolution), etc. Convolution operations can be used for image processing, image segmentation, object detection and/or classification, etc. Convolution operations can be power-intensive and/or computing-intensive operations. For example, each unit or value of output data for a convolution operation may be generated based on performing a plurality of multiply-accumulate (MAC) operations. The number of MAC operations per output value of a convolution operation can be based on the convolution type, the convolution kernel size, channel size, etc., used to perform the convolution. For example, a 3×3 convolution with 64 input channels may use 3·3·64=576 MAC operations per output data of the convolution operation (e.g., the element-wise multiplication and subsequent summation performed for each step of sliding the 3×3 convolution kernel uses 576 MAC operations).

In some examples, a relatively large proportion of the total power usage associated with performing convolutional operations is used for transferring data from local storage (e.g., RAM and/or other computer memory, etc.) to compute units (CUs) configured to implement the CNN or other convolution-based machine learning network or operation(s). For instance, in the above example of a 3×3 convolution with 64 input channels, each output value of the convolution utilizes 576 MAC operations. Each of the 576 MAC operations uses at least one byte of activation data and one byte of weight data, corresponding to a total of at least 1,152 bytes of DDR/RAM data read needed to calculate a single output value of the 64-channel 3×3 convolution kernel.

Systems and techniques that can be used to reduce the power consumption and/or computational workload associated with performing convolutional operations may be beneficial. Systems and techniques that can more efficiently perform storage, fetching, and/or transfer of data associated with convolution operations (e.g., storing, fetching, and/or transfer of data corresponding to the different convolution kernels or filters, and respective weight values thereof, for a CNN or other convolution-based machine learning network) can also be beneficial. Reducing the quantity of data fetches (e.g., data reads) and/or data transfers associated with convolution operations can also beneficial.

Systems, apparatuses, methods (also referred to as processes), and computer-readable media (collectively referred to as “systems and techniques”) are described herein that can be used to perform convolution acceleration for convolution-based machine learning networks, such as a CNN and/or other convolution-based machine learning network. According to various aspects, the convolution acceleration can be based on convolution kernel compression for one or more of a plurality of convolution kernels (e.g., filters) associated with the convolution-based machine learning network. In some examples, the convolution acceleration can be implemented by reducing the parameter storage for the convolution kernels of the convolution-based machine learning network, based on re-use of one or more portions of convolution kernel parameters across multiple convolution kernels of the machine learning network. The re-use of the one or more portions of convolution kernel parameters can be based on learned linear independence information indicative of overlap or correspondence between respective portions of two or more convolution kernels included in or implemented by the convolution-based machine learning network.

For example, based on using the learned linear independence information to identify the respective portions of multiple convolution kernels where re-use can be performed, the shared filter parameter values (e.g., weights) within the re-used portion shared across N convolution kernels of the convolution-based machine learning network may be stored in fewer than N separate instances (e.g., less than a one-to-one correspondence). In some cases, the shared filter parameter values can be stored in a single instance or single data representation that can be used by each of the N convolution kernels (e.g., a one-to-many correspondence). The N convolution kernels associated with convolution kernel re-use information (e.g., a portion of shared filter parameter values) can comprise a subset of the plurality of convolution kernels of the convolution-based machine learning network. For example, different shared filter parameter values can be identified, using the learned linear independence information, for different groups and/or combinations of the various portions of the plurality of convolution kernels of the convolution-based machine learning network.

For a respective portion of shared filter parameter values, the corresponding subset of the plurality of convolution kernels that utilize the shared filter parameter values may be individual convolution kernels that include the shared filter parameters exactly (e.g., a portion of the individual convolution kernel is the same as the shared filter parameter values), and/or individual convolution kernels that include respective filter parameter values that can be derived from the shared filter parameters (e.g., a portion of the individual convolution kernel is a multiple of the shared filter parameter values).

In some aspects, the systems and techniques can be used to provide convolution acceleration implemented based on compressing the convolution kernels of a convolution-based machine learning network (e.g., a CNN or other convolution-based machine learning network) according to a plurality of sets or subsets of shared filter parameter valued identified across the plurality of convolution kernels of the network according to the learned linear independence information. Compression of the convolution kernels can correspond to pruning redundant storage of the identified shared filter parameter values for multiple different convolution kernels. For example, storing, fetching, and implementing a first and second convolution kernel both using a respective indicator or pointer mapping to the same set of shared filter parameter values can use less data traffic (e.g., memory bandwidth), less data storage, less power, and/or less computation than storing the full set of filter parameter values for the first convolution kernel and the full set of filter parameter values for the second convolution kernel. The decrease in memory bandwidth, power consumption, and parameter storage may scale with the size or dimension of the convolution kernels, the number of convolution kernels, and the degree of correlation and/or re-use across the respective portions of the individual convolution kernels, etc.

Various aspects of the present disclosure will be described with respect to the figures.

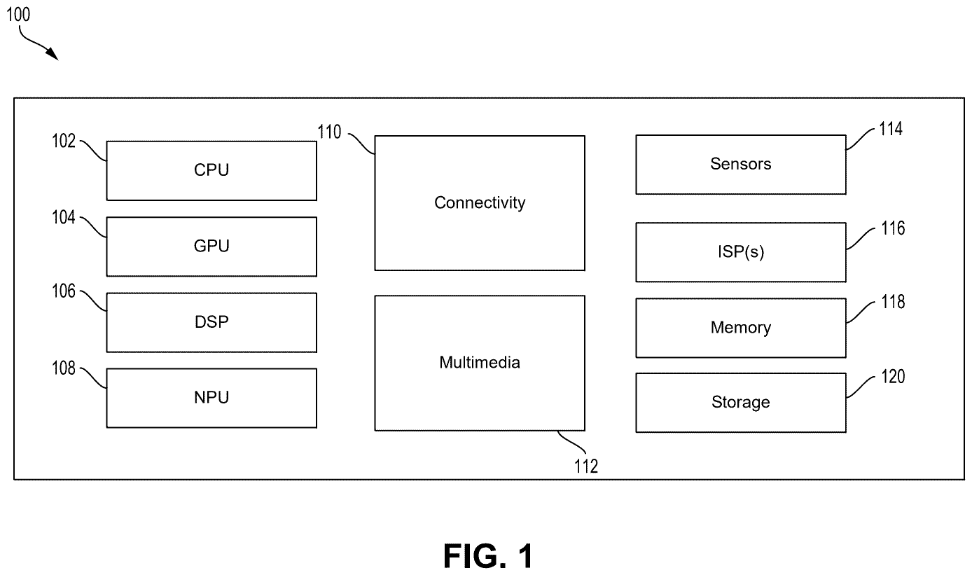

FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In some implementations, the NPU is implemented in the CPU 102, DSP 106, and/or GPU 104. The SOC 100 may also include a sensor processor 114, image signal processors (ISPs) 116, and/or storage 120.

The SOC 100 may be based on an ARM instruction set, among various others. In an aspect of the present disclosure, the instructions loaded into the CPU 102 may comprise code to search for a stored multiplication result in a lookup table (LUT) corresponding to a multiplication product of an input value and a filter weight. The instructions loaded into the CPU 102 may also comprise code to disable a multiplier during a multiplication operation of the multiplication product when a lookup table hit of the multiplication product is detected. In addition, the instructions loaded into the CPU 102 may comprise code to store a computed multiplication product of the input value and the filter weight when a lookup table miss of the multiplication product is detected.

SOC 100 can be part of a computing device or multiple computing devices. In some examples, SOC 100 can be part of an electronic device (or devices) such as a camera system (e.g., a digital camera, an IP camera, a video camera, a security camera, etc.), a telephone system (e.g., a smartphone, a cellular telephone, a conferencing system, etc.), a desktop computer, an XR device (e.g., a head-mounted display, etc.), a smart wearable device (e.g., a smart watch, smart glasses, etc.), a laptop or notebook computer, a tablet computer, a set-top box, a television, a display device, a system-on-chip (SoC), a digital media player, a gaming console, a video streaming device, a server, a drone, a computer in a car, an Internet-of-Things (IoT) device, or any other suitable electronic device(s).

In some implementations, the CPU 102, the GPU 104, the DSP 106, the NPU 108, the connectivity block 110, the multimedia processor 112, the one or more sensors 114, the ISPs 116, the memory block 118 and/or the storage 120 can be part of the same computing device. For example, in some cases, the CPU 102, the GPU 104, the DSP 106, the NPU 108, the connectivity block 110, the multimedia processor 112, the one or more sensors 114, the ISPs 116, the memory block 118 and/or the storage 120 can be integrated into a smartphone, laptop, tablet computer, smart wearable device, video gaming system, server, and/or any other computing device. In other implementations, the CPU 102, the GPU 104, the DSP 106, the NPU 108, the connectivity block 110, the multimedia processor 112, the one or more sensors 114, the ISPs 116, the memory block 118 and/or the storage 120 can be part of two or more separate computing devices.

Machine learning (ML) can be considered a subset of artificial intelligence (AI). ML systems can include algorithms and statistical models that computer systems can use to perform various tasks by relying on patterns and inference, without the use of explicit instructions. One example of a ML system is a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding this output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is one example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases. Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

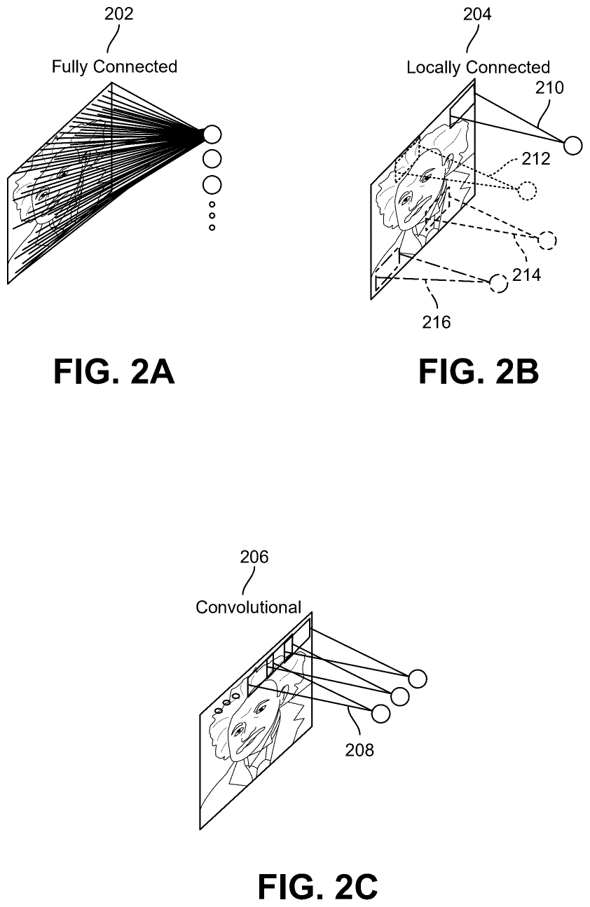

The connections between layers of a neural network may be fully connected or locally connected. FIG. 2A illustrates an example of a fully connected neural network 202. In a fully connected neural network 202, a neuron in a first hidden layer may communicate its output to every neuron in a second hidden layer, so that each neuron in the second layer will receive input from every neuron in the first layer. FIG. 2B illustrates an example of a locally connected neural network 204. In a locally connected neural network 204, a neuron in a first hidden layer may be connected to a limited number of neurons in a second hidden layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

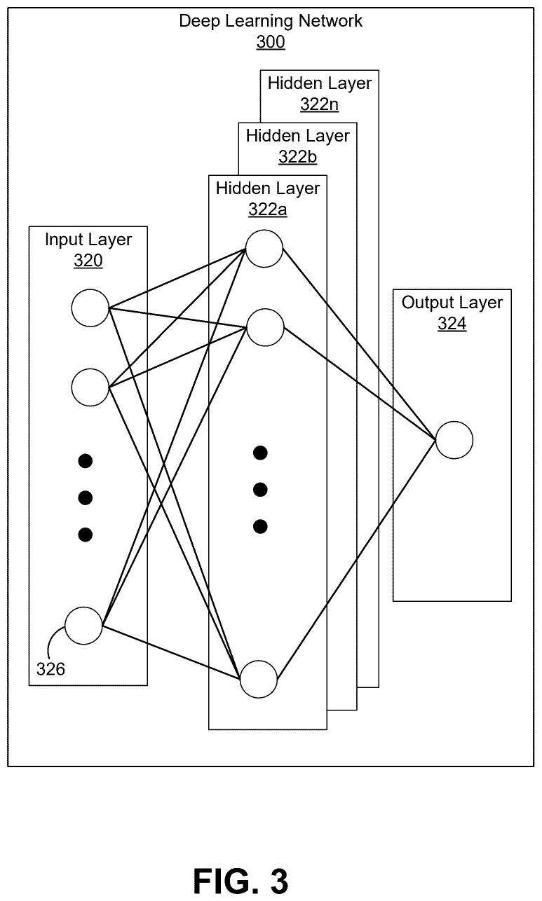

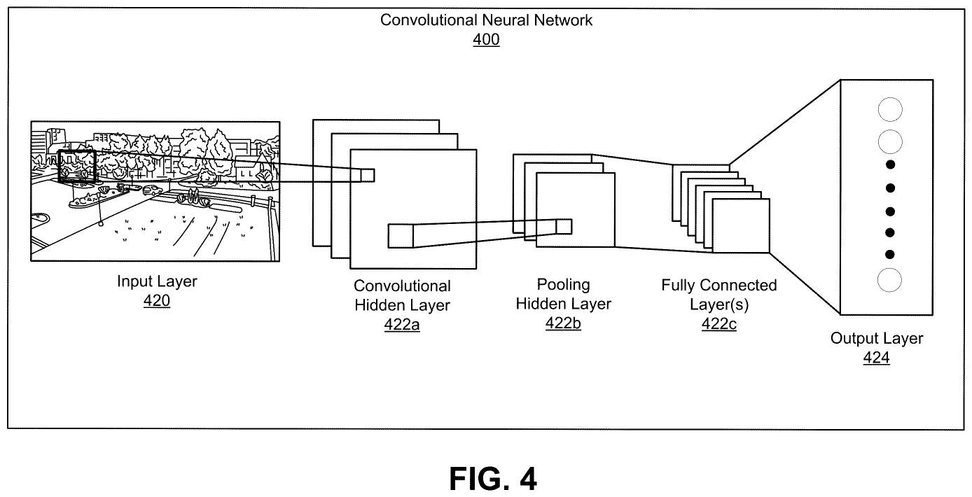

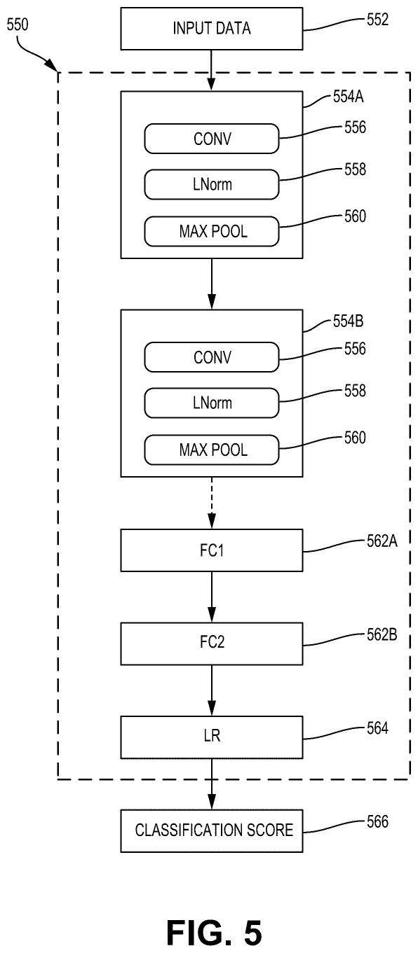

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. An illustrative example of a deep learning network is described in greater depth with respect to the example block diagram of FIG. 3. Illustrative examples of convolutional neural networks are described in greater depth with respect to the example block diagrams of FIGS. 4-5.

FIG. 3 is an illustrative example of a deep learning neural network 300. An input layer 320 includes input data. In some cases, the input layer 320 can include data representing the pixels of an input video frame. The neural network 300 includes multiple hidden layers 322a, 322b, through 322n. The hidden layers 322a, 322b, through 322n include “n” number of hidden layers, where “n” is an integer greater than or equal to one. The number of hidden layers can be made to include as many layers as needed for the given application. The neural network 300 further includes an output layer 324 that provides an output resulting from the processing performed by the hidden layers 322a, 322b, through 322n. In some aspects, the output layer 324 can provide a classification for an object in an input video frame. The classification can include a class identifying the type of object (e.g., a person, a dog, a cat, or other object).

The neural network 300 is a multi-layer neural network of interconnected nodes. Each node can represent a piece of information. Information associated with the nodes is shared among the different layers and each layer retains information as information is processed. In some cases, the neural network 300 can include a feed-forward network, in which case there are no feedback connections where outputs of the network are fed back into itself. In some cases, the neural network 300 can include a recurrent neural network, which can have loops that allow information to be carried across nodes while reading in input.

Information can be exchanged between nodes through node-to-node interconnections between the various layers. Nodes of the input layer 320 can activate a set of nodes in the first hidden layer 322a. For example, as shown, each of the input nodes of the input layer 320 is connected to each of the nodes of the first hidden layer 322a. The nodes of the hidden layers 322a, 322b, through 322n can transform the information of each input node by applying activation functions to the information. The information derived from the transformation can then be passed to and can activate the nodes of the next hidden layer 322b, which can perform their own designated functions. Example functions include convolutional, up-sampling, data transformation, and/or any other suitable functions. The output of the hidden layer 322b can then activate nodes of the next hidden layer, and so on. The output of the last hidden layer 322n can activate one or more nodes of the output layer 324, at which an output is provided. In some cases, while nodes (e.g., node 326) in the neural network 300 are shown as having multiple output lines, a node has a single output and all lines shown as being output from a node represent the same output value.

In some cases, each node or interconnection between nodes can have a weight that is a set of parameters derived from the training of the neural network 300. Once the neural network 300 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 300 to be adaptive to inputs and able to learn as more and more data is processed.

The neural network 300 is pre-trained to process the features from the data in the input layer 320 using the different hidden layers 322a, 322b, through 322n in order to provide the output through the output layer 324. In an example in which the neural network 300 is used to identify objects in images, the neural network 300 can be trained using training data that includes both images and labels. For instance, training images can be input into the network, with each training image having a label indicating the classes of the one or more objects in each image (basically, indicating to the network what the objects are and what features they have). In some examples, a training image can include an image of a number 2, in which case the label for the image can be [0 0 1 0 0 0 0 0 0 0].

In some cases, the neural network 300 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 300 is trained well enough so that the weights of the layers are accurately tuned.

The neural network 300 can include any suitable deep network. One example includes a convolutional neural network (CNN), which includes an input layer and an output layer, with multiple hidden layers between the input and out layers. An example of a CNN is described below with respect to FIG. 4. The hidden layers of a CNN include a series of convolutional, nonlinear, pooling (for downsampling), and fully connected layers. The neural network 300 can include any other deep network other than a CNN, such as an autoencoder, a deep belief nets (DBNs), a Recurrent Neural Networks (RNNs), among others.

FIG. 4 is an illustrative example of a convolutional neural network 400 (CNN 400). The input layer 420 of the CNN 400 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 422a, an optional non-linear activation layer, a pooling hidden layer 422b, and fully connected hidden layers 422c to get an output at the output layer 424. While only one of each hidden layer is shown in FIG. 4, multiple convolutional hidden layers, non-linear layers, pooling hidden layers, and/or fully connected layers can be included in the CNN 400. As previously described, the output can indicate a single class of an object or can include a probability of classes that best describe the object in the image.

The first layer of the CNN 400 is the convolutional hidden layer 422a. The convolutional hidden layer 422a analyzes the image data of the input layer 420. Each node of the convolutional hidden layer 422a is connected to a region of nodes (pixels) of the input image called a receptive field. The convolutional hidden layer 422a can be considered as one or more filters (each filter corresponding to a different activation or feature map), with each convolutional iteration of a filter being a node or neuron of the convolutional hidden layer 422a. For example, the region of the input image that a filter covers at each convolutional iteration would be the receptive field for the filter. In some aspects, if the input image includes a 28×28 array, and each filter (and corresponding receptive field) is a 5×5 array, then there will be 24×24 nodes in the convolutional hidden layer 422a. Each connection between a node and a receptive field for that node learns a weight and, in some cases, an overall bias such that each node learns to analyze its particular local receptive field in the input image. Each node of the hidden layer 422a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 422a is due to each node of the convolutional layer being applied to its corresponding receptive field. For example, a filter of the convolutional hidden layer 422a can begin in the top-left corner of the input image array and can convolve around the input image. As noted above, each convolutional iteration of the filter can be considered a node or neuron of the convolutional hidden layer 422a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 422a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 422a.

The mapping from the input layer to the convolutional hidden layer 422a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 422a can include several activation maps in order to identify multiple features in an image. The example shown in FIG. 4 includes three activation maps. Using three activation maps, the convolutional hidden layer 422a can detect three different kinds of features, with each feature being detectable across the entire image.

In some examples, a non-linear hidden layer can be applied after the convolutional hidden layer 422a. The non-linear layer can be used to introduce non-linearity to a system that has been computing linear operations. An example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 400 without affecting the receptive fields of the convolutional hidden layer 422a.

The pooling hidden layer 422b can be applied after the convolutional hidden layer 422a (and after the non-linear hidden layer when used). The pooling hidden layer 422b is used to simplify the information in the output from the convolutional hidden layer 422a. For example, the pooling hidden layer 422b can take each activation map output from the convolutional hidden layer 422a and generates a condensed activation map (or feature map) using a pooling function. Max-pooling is an example of a function performed by a pooling hidden layer. Other forms of pooling functions be used by the pooling hidden layer 422a, such as average pooling, L2-norm pooling, or other suitable pooling functions. A pooling function (e.g., a max-pooling filter, an L2-norm filter, or other suitable pooling filter) is applied to each activation map included in the convolutional hidden layer 422a. In the example shown in FIG. 4, three pooling filters are used for the three activation maps in the convolutional hidden layer 422a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 422a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 422a having a dimension of 24×24 nodes, the output from the pooling hidden layer 422b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output. Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 400.

The final layer of connections in the network is a fully-connected layer that connects every node from the pooling hidden layer 422b to every one of the output nodes in the output layer 424. Using the example above, the input layer includes 28×28 nodes encoding the pixel intensities of the input image, the convolutional hidden layer 422a includes 3×24×24 hidden feature nodes based on application of a 5×5 local receptive field (for the filters) to three activation maps, and the pooling layer 422b includes a layer of 3×12×12 hidden feature nodes based on application of max-pooling filter to 2×2 regions across each of the three feature maps. Extending this example, the output layer 424 can include ten output nodes. In such an example, every node of the 3×12×12 pooling hidden layer 422b is connected to every node of the output layer 424.

The fully connected layer 422c can obtain the output of the previous pooling layer 422b (which should represent the activation maps of high-level features) and determines the features that most correlate to a particular class. For example, the fully connected layer 422c layer can determine the high-level features that most strongly correlate to a particular class, and can include weights (nodes) for the high-level features. A product can be computed between the weights of the fully connected layer 422c and the pooling hidden layer 422b to obtain probabilities for the different classes. For example, if the CNN 400 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person). In some examples, the output from the output layer 424 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In some cases, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

One type of convolutional neural network is a deep convolutional network (DCN). Another example of a convolutional neural network is a deep belief networks (DBN). DBNs are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information associated with the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods. For example, a DCN may be trained with supervised learning. During training, a DCN may be presented with an image, such as a cropped image of a speed limit sign, and a “forward pass” may then be computed to produce an output. The output may be a vector of values corresponding to features. Before training, the output produced by the DCN is likely to be incorrect, and so an error may be calculated between the actual output and the target output. The weights of the DCN may then be adjusted so that the output scores of the DCN are more closely aligned with the target.

To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error. This manner of adjusting the weights may be referred to as “back propagation” as it involves a “backward pass” through the neural network. In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output that may be considered an inference or a prediction of the DCN.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections. The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layers, with each element of the feature map receiving input from a range of neurons in the previous layer and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

FIG. 5 is a block diagram illustrating an example of a deep convolutional network (DCN) 550. The deep convolutional network 550 may include multiple different types of layers based on connectivity and weight sharing. As shown in FIG. 5, the deep convolutional network 550 includes the convolution blocks 554A, 554B. Each of the convolution blocks 554A, 554B may be configured with a convolution layer (CONV) 556, a normalization layer (LNorm) 558, and a max pooling layer (MAX POOL) 560.

The convolution layers 556 may include one or more convolutional filters, which may be applied to the input data 552 to generate a feature map. Although only two convolution blocks 554A, 554B are shown, the present disclosure is not so limiting, and instead, any number of convolution blocks (e.g., blocks 554A, 554B) may be included in the deep convolutional network 550 according to design preference. The normalization layer 558 may normalize the output of the convolution filters. For example, the normalization layer 558 may provide whitening or lateral inhibition. The max pooling layer 560 may provide down sampling aggregation over space for local invariance and dimensionality reduction.

The parallel filter banks, for example, of a deep convolutional network may be loaded on a CPU, GPU, NPU, NSP, ASIC, FPGA, programmable logic device(s), etc., of an SOC (e.g., such as the CPU 102, GPU 104, NPU 108, etc., of the SOC 100 of FIG. 1, etc.) to achieve high performance and low power consumption. In alternative aspects, the parallel filter banks may be loaded on the DSP 106 or an ISP 56 of the SOC 100 of FIG. 1. In addition, the deep convolutional network 550 may access other processing blocks that may be present on the SOC 100 of FIG. 1, such as sensor processor 114 and storage 120, etc.

The deep convolutional network 550 may also include one or more fully connected layers, such as layer 562A (labeled “FC1”) and layer 562B (labeled “FC2”). The deep convolutional network 550 may further include a logistic regression (LR) layer 564. Between each layer 556, 558, 560, 562A, 562B, 564 of the deep convolutional network 550 are weights (not shown) that are to be updated. The output of each of the layers (e.g., 556, 558, 560, 562A, 562B, 564) may serve as an input of a succeeding one of the layers (e.g., 556, 558, 560, 562A, 562B, 564) in the deep convolutional network 550 to learn hierarchical feature representations from input data 552 (e.g., images, audio, video, sensor data and/or other input data) supplied at the first of the convolution blocks 554A. The output of the deep convolutional network 550 is a classification score 566 for the input data 552. The classification score 566 may be a set of probabilities, where each probability is the probability of the input data including a feature from a set of features.

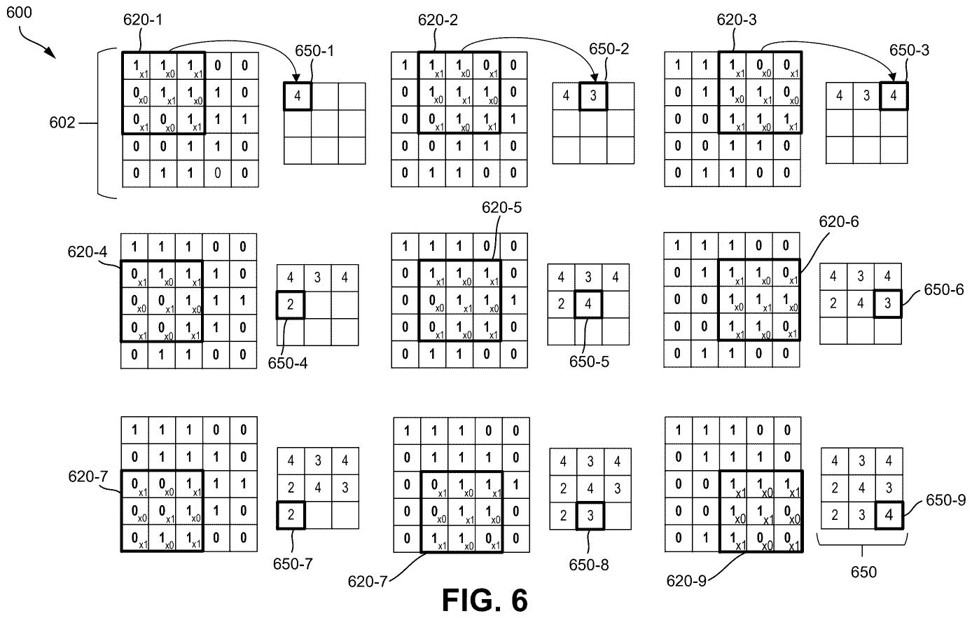

As noted above, the systems and techniques described herein can be used to perform convolution acceleration for a convolution-based machine learning network, such as a CNN and/or other convolution-based machine learning network. The convolution acceleration can be based on convolution kernel compression for one or more of a plurality of convolution kernels (e.g., filters) associated with the convolution-based machine learning network. For example, FIG. 6 is a diagram illustrating an example of convolution 600, which can correspond to convolution performed by a CNN and/or other convolution-based machine learning network, in accordance with some examples. The convolution 600 of FIG. 6 may be performed using a 3×3 sliding convolution kernel and nine different positions of the 3×3 convolution kernel on a 5×5 matrix input 602. In one illustrative example, the matrix input 602 may be an image comprising a plurality of pixels arranged in a grid (e.g., matrix) form.

As also noted above, a convolution kernel can be implemented as a matrix of weights that slides over the input data provided to a CNN. For example, a 3×3 convolution kernel can be a 3×3 matrix of weights that slides over the input data 602, processing a respective 3×3 portion of the input data 602 for each different position of the sliding convolution kernel. The example convolution 600 of FIG. 6 corresponds to the nine respective positions 620-1, 620-2, 620-3, 620-4, 620-5, 620-6, 620-7, 620-8, and 620-9 of the convolution kernel overlaid on the matrix of input data 602.

For example, the 3×3 convolution kernel can be used to process an image based on sliding across the rows of pixels included in the image. At each step, the 3×3 convolution kernel can process three columns of pixels in three different rows (e.g., three columns and three rows corresponding to the size or dimension of the 3×3 convolution kernel). In each position of the 3×3 convolution kernel sliding across the input image 602, the convolution kernel weight values are used to perform an elementwise multiplication with the respective pixels of image data 602 that are within the 3×3 window of the convolution kernel at the current position.

For example, the convolution kernel filter weights for example convolution 600 can be:

| | | |
|---|---|---|
| 1 | 0 | 1 |
| 0 | 1 | 0 |
| 1 | 0 | 1 |

In the first position 620-1 of the convolution kernel on the input matrix data 602, the sliding convolution window includes the input data:

| | | |
|---|---|---|
| 1 | 1 | 1 |
| 0 | 1 | 1 |
| 0 | 0 | 1 |

The convolved output value between the input image data 602 and the sliding convolution kernel in the first position 620-1 can be determined by summing the result of the element-wise multiplication between the convolution kernel filter weights and the corresponding portion of input image data 602 that is within the sliding window. The value of the summed element-wise multiplication is provided as a first entry 650-1 (e.g., corresponding to the first sliding window convolution position 620-1) in the convolved feature output 650. The full convolved feature output 650 is obtained after performing the convolution for all configured positions of the convolution kernel sliding over the input matrix of data 602 (e.g., obtained after calculating the last entry 650-9 for the last convolved output value corresponding the last sliding convolution kernel position 620-9) is a matrix of the same size as the convolution kernel. For example, the full convolved feature output for the example convolution 600 of FIG. 6 is the 3×3 convolved feature 650.

For each different position of the sliding convolution kernel, element-wise multiplication and addition is performed between the 3×3 matrix of filter weights for the convolution kernel, and the 3×3 subset of the matrix of input values 602 that are located within the current sliding window position. For example, the first cycle of the convolution 600 corresponds to the first sliding kernel position 620-1, and can be performed to obtain the first entry 650-1 of the convolved output between the kernel filter weights and the corresponding portion of the input values 602 for the first sliding window position. The first entry 650-1 of the convolved output can be equal to a value of 4, which is the sum of the corresponding element-wise multiplication (e.g., from the top-left to bottom-right of the 3×3 area, equal to 1·1+1·0+1·1+0·0+1·1+1·0+0·1+0·0+1·1=4).

The second cycle of the convolution 600 corresponds to the second sliding kernel position 620-2, and can be performed to obtain the second entry 650-2 of the convolved output between the kernel filter weights and the corresponding portion of the input values 602 for the second sliding window position. The second entry 650-2 of the convolved output can be equal to a value of 3, which is the sum of the corresponding element-wise multiplication 1·1+1·0+0·1+1·0+1·1+1·0+0.1+1·0+1·1=3.

The third cycle of the convolution 600 corresponds to the third sliding kernel position 620-3, and can be performed to obtain the third entry 650-3 of the convolved output between the kernel filter weights and the corresponding portion of the input values 602 for the third sliding window position. The third entry 650-3 of the convolved output can be equal to a value of 4, which is the sum of the corresponding element-wise multiplication 1·1+0·0+0·1+1·0+1·1+0·0+1·1+1·0+1·1.

The fourth cycle of the convolution 600 corresponds to the fourth sliding kernel position 620-4, and can be performed to obtain the fourth entry 650-4 of the convolved output between the kernel filter weights and the corresponding portion of the input values 602 for the fourth sliding window position, where the fourth entry 650-4 has a value of 2.

The fifth cycle of the convolution 600 corresponds to the fifth sliding kernel position 620-5, and can be performed to obtain the fifth entry 650-5 of the convolved output between the kernel filter weights and the corresponding portion of the input values 602 for the fifth sliding window position, where the fifth entry 650-5 has a value of 4. The sixth cycle of the convolution 600 corresponds to the sixth sliding kernel position 620-6, and can be performed to obtain the sixth entry 650-6 of the convolved output between the kernel filter weights and the corresponding portion of the input values 602 for the sixth sliding window position, where the sixth entry 650-6 has a value of 3. The seventh cycle of the convolution 600 corresponds to the seventh sliding kernel position 620-7, and can be performed to obtain the seventh entry 650-7 of the convolved output between the kernel filter weights and the corresponding portion of the input values 602 for the seventh sliding window position, where the seventh entry 650-7 has a value of 2. The eighth cycle of the convolution 600 corresponds to the eighth sliding kernel position 620-8, and can be performed to obtain the eighth entry 650-8 of the convolved output between the kernel filter weights and the corresponding portion of the input values 602 for the eighth sliding window position, where the eighth entry 650-8 has a value of 3. The ninth cycle of the convolution 600 corresponds to the ninth sliding kernel position 620-9, and can be performed to obtain the ninth entry 650-9 of the convolved output between the kernel filter weights and the corresponding portion of the input values 602 for the ninth sliding window position, where the ninth entry 650-9 has a value of 4.

To perform convolution operations (e.g., such as the convolution 600 of FIG. 6), a CNN or other convolution-based machine learning network may perform a number of multiplication operations that is approximately equal to the number of different entries (e.g., filter weight values, etc.) within the convolution kernel, multiplied by the number of different positions of the sliding kernel over the input image or matrix of data, multiplied by the number of channels (e.g., the convolution 600 of FIG. 6 corresponds to the calculations for only a single channel), and still further multiplied by the number of different convolution kernels used by the network (e.g., in examples where a plurality of different convolution kernel filter weights are used to process the same underlying image or matrix of input values 602, etc.).

For various CNNs and convolution-based machine learning networks and/or systems, a relatively large proportion of the total power usage associated with performing convolutional operations may be used for transferring data from local storage (e.g., RAM and/or other computer memory, etc.) to compute units (CUs) configured to implement the CNN or other convolution-based machine learning network or operation(s). For instance, if the example 3×3 convolution 600 of FIG. 6 is configured for convolutional operations using 64 input channels, each output value of the convolution (e.g., each entry of the nine entries in the convolved feature output 650) utilizes 3.3.64=576 multiply-accumulate (MAC) operations. Each of the 576 MAC operations may utilize at least one byte of activation data and at least one byte of weight data, corresponding to a total of at least 576.2=1,152 bytes of RAM or other computer memory I/O operations in order to calculate a single entry of the convolved feature output 650 for a single channel of a convolution kernel being applied to a single matrix input 602. The memory bandwidth, power consumption or usage, and convolution kernel filter parameter weight storage size scale rapidly with real world implementations of more complex CNNs and convolution-based machine learning networks that utilize larger inputs and/or convolution kernel sizes, as well as multiple convolution layers and/or fully connected layers within the CNN model architecture, etc.

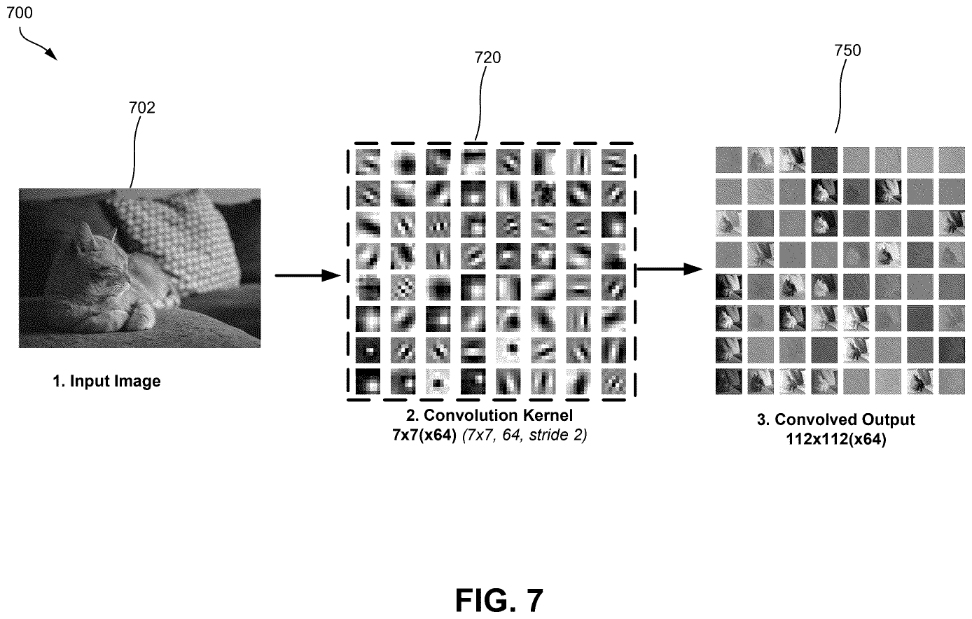

For example, a 7×7 convolution kernel (e.g., such as the example 7×7 convolution kernel of FIG. 7, described below) applied using 64 input channels utilizes at least 3, 136 bytes of memory I/O for calculating each entry of the 7×7 convolved feature output. A 3×3 convolution kernel using 128 input channels utilizes at least 1,152 bytes of memory I/O per entry of the 3×3 convolved feature output. A 3×3 convolution kernel using 256 input channels uses at least 2,304 bytes of memory I/O for calculating each entry of the 3×3 convolved feature output. A 3×3 convolution kernel using 512 input channels uses at least 4,608 bytes of memory I/O for each entry of the 3×3 convolved feature output. In some aspects, the size of a convolution in number of bytes (e.g., number of bytes of memory I/O, as in the examples above) can correspond to or be indicative of at least one of memory requirements associated with performing the convolution, and/or computational requirements associated with performing the convolution. In some cases, current CNNs and/or convolution-based machine learning networks may be associated with large numbers of parameters and weights that are used to perform the convolution calculations. For example, CNNs and/or other convolution-based machine learning networks can be associated with DDR (e.g., memory) bandwidths of 30-70 gigabytes per second (GB/s).

FIG. 7 is a diagram illustrating an example of convolutional processing 700 of an input image 702 (e.g., or other input of matrix values, etc.) using a plurality of convolution kernels, in accordance with some examples. As noted above, a convolution kernel may also be referred to as a “filter.” For example, a convolution kernel may be implemented as a learned convolution filter within a layer (or one or more layers) of a CNN or other convolution-based machine learning network. Convolution operations performed for an input image or matrix of values can correspond to applying a plurality of different convolution filters with a sliding window of patches across or within the input image. For example, as noted above, the convolution 600 of FIG. 6 is an example of a single convolution filter (e.g., convolution kernel) as it is applied to the full frame of the input image 602. The single convolution filter (e.g., kernel) 602 of FIG. 6 can be included in a plurality of convolution filters implemented or applied by a CNN or other convolution-based machine learning network. In some aspects, a convolutional layer of a CNN or other machine learning network can include at least one convolution kernel for each dimension of the convolutional layer. In one illustrative example, the input image 702 of FIG. 7 may be an RGB image with dimensions of 224×224×3 (e.g., 224 pixels in width and height, and 3 channels corresponding to red, green, and blue color information of each pixel). The input image 702 may also be a non-RGB image, and/or may have dimensions different from (e.g., larger and/or smaller, etc.) the illustrative example of the dimensions of 224×224×3. The convolutional processing 700 of FIG. 7 can be implemented using a convolution kernel 720, which includes a plurality of individual convolution filters that may be applied by for element-wise multiplication and summation (e.g., multiply-accumulate) for a sliding window of patches of the underlying input pixel data 702. In one illustrative example, the convolution kernel 720 is a 7×7×64 convolution kernel, which can include 64 different convolution filters each having a respective 7×7 grid of filter weight values.

The convolution kernel 720 is represented in the example of FIG. 7 as an 8×8 grid of tiles, with each tile representing the convolved output of a particular one of the 64 convolution filters of the convolution kernel 720 being convolved with the entire input image 702. The arrangement of convolution kernel 720 as the 8×8 tiled grid representation shown in FIG. 7 is utilized for representative example, rather than indicating different spatial correspondence between different convolution kernel 720 tiles and different portions of the input image 702 (e.g., each of convolved outputs in the 8×8 grid of the convolution kernel 720 represented in FIG. 7 is convolved over the entire input image 702, with each one of the 64 different convolution filter of the kernel 720 having the same starting position, ending position, and intermediate sequence of sliding positions or pixel patch windows within the input image 702 between the starting and ending position, etc.).

In the example of FIG. 7, the convolution kernel 720 includes 64 convolution filters corresponding to the 64 input channel configuration for the convolution operation 700. The convolution kernel 720 can also be configured with different stride values, where the stride is indicative of the step size as the convolution kernel slides between adjacent positions within the input image 702. For example, stride=1 corresponds to sliding the 7×7 convolution kernel window by one pixel at each step or cycle. A configuration with stride=2 corresponds to sliding the 7×7 convolution kernel window by two pixels at each step or cycle, . . . , etc. The convolved output 750 of the convolution operation 700 may be scaled according to the stride of the convolution kernel 720. For example, with stride=1, the dimensions of the convolved output may be the same as the dimensions of the input image or matrix of data 702. With stride=2, the spatial dimensions of the convolved output 750 are reduced by a factor equal to the stride (e.g., spatial dimensions are reduced by a factor of 2). For example, the 7×7×64 convolution kernel 720 can be applied to the input image 702 to generate a convolved output 750 comprising a respective convolved entry or value for each one of the 64 convolution filters included in the convolution kernel 720, where the output dimension of each convolved output has from one of the 64 different 7×7 convolution filters of the kernel 720 is equal to 112×112 (e.g., for a total convolved output 750 dimension of 112×112×64 when including the channel dimension of 64) based on using a stride=2 and reducing the input image 702 spatial dimension of 224×224 by half.

The example convolution kernel 720 of FIG. 7 illustrates a respective representation of each of the 64 convolution filters using the grayscale shading within the individual tiles in the 8×8 grid used to represent the convolution kernel 720. For example, each small tile within the 8×8 grid of the convolution kernel 720 shows the weights of a single 7×7 convolution filter visualized as a 2D grayscale image (e.g., a digitalized 8-bit kernel value, corresponding to the representation of each convolution filter tile as an 8×8 grayscale tile). The grayscale image tile representation or visualization of the convolution filters of the convolution kernel 720 illustrates the average or combined effect of the convolution filter processing applied per input channel of the RGB input image 702. At each valid location, window, pixel patch, etc., within the input image 702, each one of the convolution filters represented by a respective tile of the 64 tiles of the convolution kernel 720 is slid (e.g., convolved) across the entire input image 702, and multiplied by the corresponding 7×7 patch of pixels from all three channels, summed, and combined with any bias terms to obtain a single output pixel (e.g., convolved output value or entry) for the particular convolution filter's channel (e.g., of the 64 channels of convolution filter outputs for the 7×7×64 convolution kernel 720). Performing the convolution over the entire input image 702 using each convolution filter of the plurality (e.g., 64) of convolution filters included in the convolution kernel 720 results in a complete 2D feature map 750 for the filter 720.

In some aspects, the various convolution filters included in the convolution kernel 720 may have different weights based a learning process during training of the CNN or convolution-based machine learning network that includes or implements the convolution kernel 720. For example, the weights for each convolution filter or channel of the convolution kernel 720 may be learned via backpropagation during training to detect particular patterns or structures present in the training data images provided to the machine learning network. In some examples, a convolution kernel may learn edge-like detectors that can be oriented at various angles. Other example convolution kernels may learn particular textures within input images, and/or frequency components, etc. Implementing the convolution kernel 720 with a plurality of channels (e.g., a number of convolution filters greater than the number of channels of the input image 702) can be used to train the CNN or convolution-based machine learning network to learn a more diverse set of low-level feature detectors that can improve the accuracy of the network and/or provide a richer set of features for one or more downstream layers of the network to learn to combine into increasingly complex and abstract representations of the input image 702.

In some aspects, the convolved output 750 can be a complete 2D feature map corresponding to the convolution filter 720. In some cases, the convolved output 750 can have dimensions of 112×112×64, based on the stride 2 of the convolution kernel 720 acting to downscale the convolved output 750 by a factor of two from the input dimensions 224×224 of the input image 702. For example, the number of tiles shown in the convolved output 750 can be equal to the number of tiles (e.g., 64) included in the convolution kernel 720, where each tile of the convolved output 750 represents the result of sliding a particular tile of the convolution kernel 720 over the input image 702 using the stride of 2.

In some aspects, the various convolution kernels (e.g., filters) included in the convolution kernel 702 can exhibit various symmetry and/or similarity characteristics with one or more additional convolution kernels (e.g., filters) that are included in the plurality of convolution kernels (e.g., filters) of the convolution kernel 720. For example, the systems and techniques can be used to perform convolution acceleration using convolution kernel compression based on one or more of inter-kernel symmetry and/or similarity (e.g., symmetry and/or similarity of respective portions within the same respective convolution kernel), and/or based on intra-kernel symmetry and/or similarity (e.g., symmetry and/or similarity of respective portions within different respective convolution kernels). In one illustrative example, the systems and techniques can be used to perform convolution acceleration and/or convolution kernel compression based on using the intra-kernel and/or inter-kernel symmetry and/or similarity characteristics to implement one or more of a reduction in the storage size of a convolution kernel comprising a plurality of convolution filters (e.g., such as the convolution kernel 720) and/or a reduction in the DDR or memory bandwidth for loading the convolution kernel comprising a plurality of convolution filters.

For example, the systems and techniques can utilize learned linear independence information to re-use computation results between portions of convolution kernels that are symmetric and/or similar within a same respective convolution kernel (e.g., intra-kernel), or within different respective convolution kernels (e.g., inter-kernel). In one illustrative example, the re-use of computation results between same or similar portions of convolution kernel filter values within a convolution kernel and/or between different convolution kernels can be performed to reduce the power consumption of one or more computing units associated with implementing the CNN or other convolution-based machine learning network.

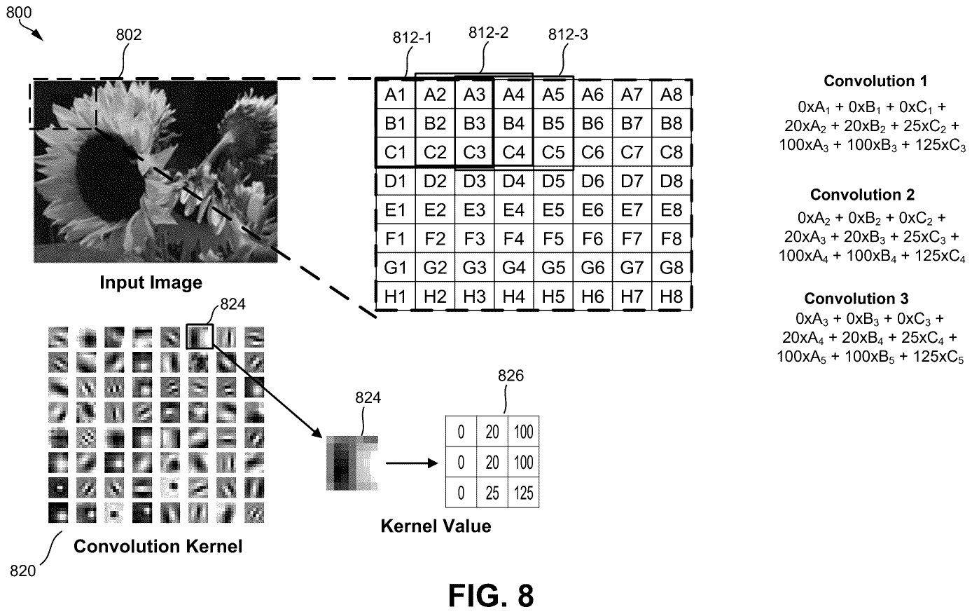

FIG. 8 is a diagram illustrating an example of intra-kernel compression 800 based on determining intra-kernel correlation and/or overlap associated with a plurality of convolution operations of a convolution kernel, in accordance with some examples. In some aspects, the intra-kernel compression 800 can be determined for a particular convolution kernel (e.g., convolution filter) that is included in a plurality of convolution filters of a convolution kernel 820. For example, the intra-kernel compression 800 can be determined based on symmetry and/or similarity information determined between respective portions of the individual convolution filter 824 included in the plurality of the convolution filters of the convolution kernel 820. In some examples, the convolution kernel 820 of FIG. 8 can be the same as or similar to the convolution kernel 720 of FIG. 7. In some aspects, the input image 802 of FIG. 8 may be the same as or similar to the input image 702 of FIG. 7.

In some examples, the input image 802 can be represented as an 8×8 grid of pixels, although it is noted larger or smaller pixel dimensions can also be utilized for the input image 802. In the example of an 8×8 pixel grid comprising the input image 802, the respective pixel positions within the input image 802 can be represented using a corresponding column identifier 1, 2, . . . , 7, 8 and a corresponding row identifier A, B, . . . , G, H.

The individual convolution filter 824 is included in the plurality of different individual convolution filters comprising the convolution kernel 820. In one illustrative example, the individual convolution filter 824 is represented as the 8-bits digitalized kernel values 826. For example, the individual convolution filter 824 can be represented as the digitalized kernel values 826:

| | | |
|---|---|---|
| 0 | 20 | 100 |
| 0 | 20 | 100 |
| 0 | 25 | 125 |

The kernel size of the respective convolution filters (e.g., 824) within the convolution kernel 820 can be larger or smaller than the example 3×3 size shown in the example of FIG. 8. In some examples, the convolution operations corresponding to the individual convolution filters 824 can be represented as the sliding window multiply and accumulate determined using the digitalized kernel values 826 over the pixels of the input image 802. For example, a first convolution operation (e.g., “Convolution 1”) can correspond to the window 812-1 of input image 802 pixels being used for element-wise multiplication with the digitalized kernel values 826 for the individual convolution filter 824:

$$Convolution 1 = 0 \cdot {A}_{1} + 0 \cdot {B}_{1} + 0 \cdot {C}_{1} + 20 \cdot {A}_{2} + 20 \cdot {B}_{2} + 25 \cdot {C}_{2} + 100 \cdot {A}_{3} + 100 \cdot {B}_{3} + 125 \cdot {C}_{3}$$

A second convolution operation (e.g., “Convolution 2”) can be performed using a second position 812-2 of the sliding window overlaid on the input image 802 pixel grid, for the element-wise multiple with the digitalized kernel values 826 for the individual convolution filter 824:

$$Convolution 2 = 0 \cdot {A}_{2} + 0 \cdot {B}_{2} + 0 \cdot {C}_{2} + 20 \cdot {A}_{3} + 20 \cdot {B}_{3} + 25 \cdot {C}_{3} + 100 \cdot {A}_{4} + 100 \cdot {B}_{4} + 125 \cdot {C}_{4}$$

A third convolution operation (e.g., “Convolution 3”) can be performed using a third position 812-3 of the sliding window overlaid on the input image 802 pixel grid for the element-wise multiplication with the digitalized kernel values 826 for the individual convolution filter 824:

$$Convolution 3 = 0 \cdot {A}_{3} + 0 \cdot {B}_{3} + 0 \cdot {C}_{3} + 20 \cdot {A}_{4} + 20 \cdot {B}_{4} + 25 \cdot {C}_{4} + 100 \cdot {A}_{5} + 100 \cdot {B}_{5} + 125 \cdot {C}_{5}$$

In the first convolution operation (e.g., “Convolution 1”), 9 multiplication and 8 addition calculations are performed between the kernel values 826 and the pixel values within the first window 812-1.

In the second convolution operation (e.g., “Convolution 2”), 9 multiplication and 8 addition calculations are performed between the kernel values 826 and the pixel values within the second window 812-2.

Between the first convolution operation (e.g., associated with the first position 812-1 of the sliding window) and the second convolution operation (e.g., associated with the second position 812-2 of the sliding window), the input pixel values A2, B2, C2 and A3, B3, C3 are overlapping, based on being included in both the first sliding window 812-1 and the second sliding window 812-2.

In the third convolution operation (e.g., “Convolution 3”), 9 multiplication and 8 addition calculations are performed between the kernel values 826 and the pixel values within the third window 812-3.

Between the second convolution operation (e.g., associated with the second position 812-2 of the sliding window) and the third convolution operation (e.g., associated with the third position 812-3 of the sliding window), the input pixel values A3, B3, C3 and A4, B4, C4 are overlapping, based on being included in both the second sliding window 812-2 and the third sliding window 812-3.

In one illustrative example, the respective overlapping portions between the different convolution operations and respective sliding window positions thereof can be used to implement convolution acceleration based on compression and re-use of portions of the convolution kernel values. For example, between the first and second convolutions, and as noted above, the input pixel values A2, B2, C2 and A3, B3, C3 are overlapping, based on being included in both the first sliding window 812-1 and the second sliding window 812-2.

In one illustrative example, the Convolution 1 operations can be rewritten as:

$$Convolution 1 = [ 0 \cdot {A}_{1} + 0 \cdot {B}_{1} + 0 \cdot {C}_{1} ] + [ 20 \cdot {A}_{2} + 20 \cdot {B}_{2} + 25 \cdot {C}_{2} ] + [ 100 \cdot {A}_{3} + 100 \cdot {B}_{3} + 125 \cdot {C}_{3} ] = [ 0 ] + [ a ] + [ b ]$$

Here, the term a=20·A₂+20·B₂+25·C₂, and the term b=100·A₃+100·B₃+125·C₃.

Based on the overlapping portions between the first sliding window 812-1 for the Convolution 1 operations and the second sliding window 812-2 for the Convolution 2 operations, the Convolution 2 operations can be simplified and re-written to re-use a portion of the already calculated results from the Convolution 1 operations:

$$Convolution 2 = [ 0 \cdot {A}_{2} + 0 \cdot {B}_{2} + 0 \cdot {C}_{2} ] + [ 20 \cdot {A}_{3} + 20 \cdot {B}_{3} + 25 \cdot {C}_{3} ] + [ 100 \cdot {A}_{4} + 100 \cdot {B}_{4} + 125 \cdot {C}_{4} ] = [ a \cdot 0 ] + [ b \cdot 0.2 ] + [ 100 \cdot {A}_{4} + 100 \cdot {B}_{4} + 125 \cdot {C}_{4} ]$$

In some aspects, the overlap and correlation between the Convolution 1 and Convolution 2 operations (e.g., determined based on the corresponding first sliding window position 812-1 in the input image 802 pixel grid and the second sliding window position 812-2 in the input image 802 pixel grid) can be used to reduce the computations associated with determining the output for the Convolution 2 operations. For example, Convolution 1 is still performed using a total of 9 multiplications and 8 additions. By rewriting Convolution 2 to reuse the terms a and b defined from the results of Convolution 1, the calculations for the Convolution 2 with re-use (e.g., a·0+b·0.2+100·A₄+100. B₄+125·C₄) can be compressed to use fewer than 9 multiplications and 8 additions. For example, the calculations for Convolution 2 with re-use of overlapping portions from Convolution 1 can be obtained using 5 multiplications and 4 additions (e.g., 4 multiplications and 4 additions can be skipped for Convolution 2, based on re-use of the terms a and b from Convolution 1 with respective weighting values applied to each). The re-use of the terms a and b from Convolution 1, with the respective weighting values of 0 and 0.2, respectively, can correspond to a 55% reduction in the number of multiplication operations performed for Convolution 2 (e.g., 5 multiplications instead of 9) and a 50% reduction in the number of addition operations performed for Convolution 2 (e.g., 4 additions instead of 8).

Based on the overlap between the second sliding window portion 812-2 and the third sliding window portion 812-3, additional compression and re-use can be implemented between the Convolution 2 operations and the Convolution 3 operations. For example, the Convolution 2 operations can be rewritten as:

$$Convolution 2 = [ 0 \cdot {A}_{2} + 0 \cdot {B}_{2} + 0 \cdot {C}_{2} ] + [ 20 \cdot {A}_{3} + 20 \cdot {B}_{3} + 25 \cdot {C}_{3} ] + [ 100 \cdot {A}_{4} + 100 \cdot {B}_{4} + 125 \cdot {C}_{4} ] = [ 0 ] + [ c ] + [ d ]$$

Here, the term c=20·A₃+20·B₃+25·C₃, and the term d=100. A₄+100·B₄+125·C₄. The terms c and d selected for re-writing the operations of Convolution 2, and subsequently, Convolution 3, can be determined according to the overlap between the sliding window 812-2 for Convolution 2 and the sliding window 812-3 for Convolution 3, as noted above.

In one illustrative example, the operations of Convolution 3 can be simplified based on re-use of the terms c and d previously computed during the operations of Convolution 2, and based on applying a respective weighting factor for each re-use term c and d. For example,

Based on the overlapping portions between the second sliding window 812-2 for the Convolution 2 operations and the third sliding window 812-3 for the Convolution 3 operations, the Convolution 3 operations can be simplified and re-written to re-use a portion of the already calculated results from the Convolution 2 operations:

$$Convolution 3 = [ 0 \cdot {A}_{3} + 0 \cdot {B}_{3} + 0 \cdot {C}_{3} ] + [ 20 \cdot {A}_{4} + 20 \cdot {B}_{4} + 25 \cdot {C}_{4} ] + [ 100 \cdot {A}_{5} + 100 \cdot {B}_{5} + 125 \cdot {C}_{5} ] = [ c \cdot 0 ] + [ d \cdot 0.2 ] + [ 100 \cdot {A}_{5} + 100 \cdot {B}_{5} + 125 \cdot {C}_{5} ]$$

In some aspects, the overlap and correlation between the Convolution 2 and Convolution 3 operations (e.g., determined based on the corresponding second sliding window position 812-2 in the input image 802 pixel grid and the third sliding window position 812-3 in the input image 802 pixel grid) can be used to reduce the computations associated with determining the output for the Convolution 3 operations.

A For example, by rewriting Convolution 3 to reuse the terms c and d defined from the results of Convolution 2, the calculations for the Convolution 3 with re-use (e.g., c·0+d·0.2+100·A₅+100·B₅+125·C₅) can be compressed to use fewer than 9 multiplications and 8 additions. For example, the calculations for Convolution 3 with re-use of overlapping portions from Convolution 2 can be obtained using 5 multiplications and 4 additions (e.g., 4 multiplications and 4 additions can be skipped for Convolution 3, based on re-use of the terms c and d from Convolution 2 with respective weighting values applied to each). The re-use of the terms c and d from Convolution 2, with the respective weighting values of 0 and 0.2, respectively, can correspond to a 55% reduction in the number of multiplication operations performed for Convolution 3 (e.g., 5 multiplications instead of 9) and a 50% reduction in the number of addition operations performed for Convolution 3 (e.g., 4 additions instead of 8).

In some aspects, based on intra-kernel similarity and/or overlap between different sliding window positions associated with the convolution operations for the same convolution kernel (e.g., convolution kernel filter weights, etc.), the systems and techniques can implement re-use of overlapping portions to achieve a reduction and/or optimization in the computing power associated with performing the convolution operations.

In some cases, bandwidth compression and/or optimization can be implemented for the convolution kernel based on the intra-kernel symmetry and/or similarities. For example, without compression, the example digitalized convolution kernel values 826 may be stored as 9 individual components (e.g., the 9 values [0, 0, 0; 20, 20, 25; 100, 100 125]). In one illustrative example, bandwidth compression can be performed to reduce the amount of storage associated with storing the convolution kernel 826. For example, based on the overlapping portions between successive sliding window positions of the convolution kernel 824 and sliding window positions 812-1, 812-2, 812-3, . . . , a 33% compression can be implemented and the convolution kernel values 826 can be stored using a total of 6 components. For example, the compressed values for convolution kernel 826 can comprise the 6 values corresponding to [row/column index, 100, 100, 125] and the scalar weights [0, 0.2] associated with the re-use implementation.

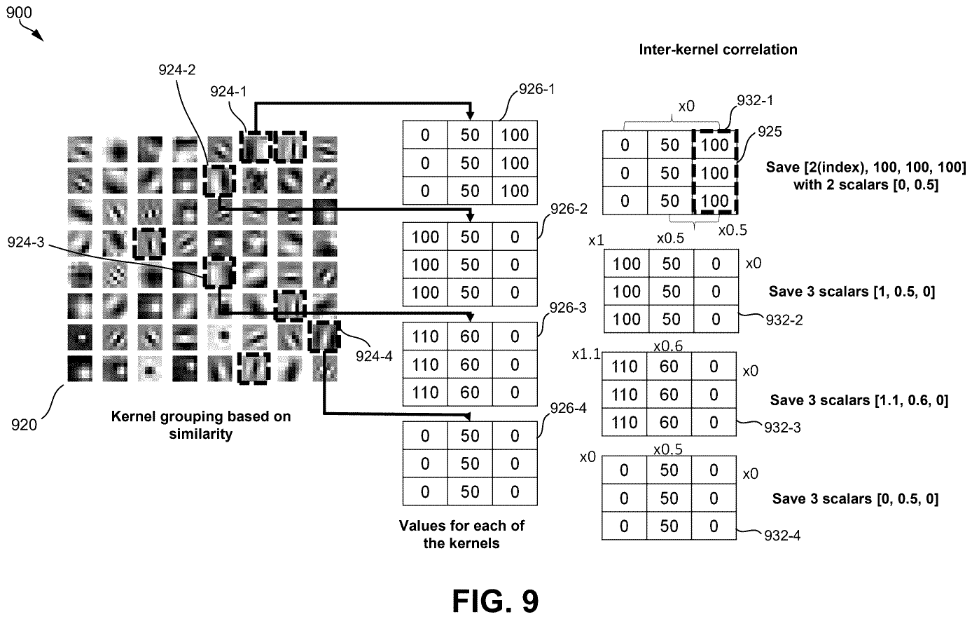

FIG. 9 is a diagram illustrating an example of inter-kernel correlation 900 and/or overlap associated with a plurality of convolution operations of a convolution kernel, in accordance with some examples. For example, the inter-kernel correlation 900 can be performed to provide bandwidth compression (e.g., reduction and/or optimization, etc.) for respective individual convolution kernels included in a plurality of convolution kernels 920. In some aspects, the convolution kernel 920 can be the same as or similar to the convolution kernel 820 of FIGS. 8 and/or 720 of FIG. 7, and can include a plurality of different convolution filters each with respective filter weights and values, etc.

In one illustrative example, the inter-kernel correlation 900 can be performed based on performing kernel grouping or clustering of the plurality of different convolution filters within the convolution kernel 920. For example, the grouping or clustering can be based on similarity or correlation and/or learned linear independence information between respective ones of the plurality of convolution filters included in the convolution kernel 920. In some aspects, each convolution filter included in the plurality of convolution filters of the convolution kernel 920 can be plotted to a corresponding digital (e.g., digitalized) value for the convolution filter weights.

For example, a first convolution filter 924-1 of the convolution kernel 920 can be plotted to the corresponding digitalized convolution filter weight values 926-1 (e.g., which can be the same as or similar to the digitalized convolution filter weights 826 of FIG. 8, etc.), comprising:

| | | |
|---|---|---|
| 0 | 50 | 100 |
| 0 | 50 | 100 |
| 0 | 50 | 100 |

A second convolution filter 924-2 of the convolution kernel 920 can be plotted to the corresponding digitalized convolution filter weight values 926-2, comprising:

| | | |
|---|---|---|
| 100 | 50 | 0 |
| 100 | 50 | 0 |
| 100 | 50 | 0 |

A third convolution filter 924-3 of the convolution kernel 920 can be plotted to the corresponding digitalized convolution filter weight values 926-3, comprising:

| | | |
|---|---|---|
| 110 | 60 | 0 |
| 110 | 60 | 0 |
| 110 | 60 | 0 |

A fourth convolution filter 924-4 of the convolution kernel 920 can be plotted to the corresponding digitalized convolution filter weight values 926-4, comprising:

| | | |
|---|---|---|
| 0 | 50 | 0 |
| 0 | 50 | 0 |
| 0 | 50 | 0 |

Using the corresponding digitalized convolution filter values (e.g., 926-1, 926-2, 926-3, 926-4, . . . , etc.), the systems and techniques can be configured to determine a correlation between inter-kernels. For example, the correlation can be determined between pairs of different respective convolution filters included in the plurality of convolution filters of the convolution kernel 920. The inter-kernel correlation information can be used to determine a respective compressed representation of the digitalized convolution filters values for each respective convolution filter included in or associated with the inter-kernel compression 900.

For example, the first convolution filter values 926-1 can be stored as the compressed representation 932-1, comprising the 6 components [row/column index, 100, 100, 100] and the scalar weights [0, 0.5]. In some aspects, the compressed representation 932-1 includes the column of values ‘100’ as an anchor portion 925 used for the inter-kernel correlation 900 between the different convolution filters 924-1, 924-2, 924-3, 924-4. For example, the compressed representations of the remaining convolution filters identified from the grouping based on similarity can be expressed as scalar multiples of the anchor portion 925 of the first convolution filter values 926-1.

In one illustrative example, the second convolution filter values 926-2 can be stored as a compressed representation 932-2 based on inter-kernel compression with the first compressed representation 932-1. For example, the second compressed representation 932-2 can be stored as the three scalar values [1.0, 0.5, 0], which can correspond to weight values to obtain the second convolution filter values 926-2 from the anchor values 925 of the first compressed representation 932-1. For example, the first column of the second convolution filter values 926-2 can be obtained by multiplying the scalar value 1.0 with the anchor values 925 of the first compressed representation 932-1. The second column of the second convolution filter values 926-2 can be obtained by multiplying the scalar value 0.5 with the first column of the second convolution filter values 926-2. The third column of the second convolution filter values 926-2 can be obtained by multiplying by the scalar value 0.

The third convolution filter values 926-3 can be stored as a third compressed representation 932-3 based on inter-kernel compression with the first compressed representation 932-1 and using the anchor portion values 925 thereof. For example, the third compressed representation 932-3 can comprise the three scalar values [1.1, 0.6, 0], which can be multiplied with the anchor values 925 of the first compressed representation 932-1 to obtain the respective first column (e.g., with values 1.1*100=110) of the third convolution filter 926-3, the respective second column (e.g., with values 0.6*100=60) of the third convolution filter 926-3, and the respective third column (e.g., with values 0*100=0) of the third convolution filter 926-3.

The fourth convolution filter values 926-4 can be stored as a fourth compressed representation 932-4 based on inter-kernel compression with the first compressed representation 932-1 and using the anchor portion values 925 thereof. For example, the fourth compressed representation 932-4 can comprise the three scalar values [0, 0.5, 0], which can be multiplied with the anchor values 925 of the first compressed representation 932-1 to obtain the respective first column of the fourth convolution filter 926-4 (e.g., with values 0*100=0), the respective second column of the fourth convolution filter 926-4 (e.g., with values 0.5*100=50), and the respective third column of the fourth convolution filter 926-4 (e.g., with values 0*100=0).

In some aspects, performing compression of one or more convolution kernels included in a plurality of convolution kernels (e.g., such as the convolution kernel compression performed based on the inter-kernel correlation 900 of FIG. 9, etc.) can correspond to generating and storing compressed representations of convolution kernels that comprise scalars. For example, the first compressed representation 932-1 of the first convolution filter values 926-1 can comprise a set of anchor values 925 (e.g., the column of values [100 100 100]) and a set of two scalars [0, 0.5]. The remaining compressed representations 932-2, 932-2, 932-3 each comprise a set of scalars only, where the underlying second, third, and fourth convolution filter values 926-2, 926-3, and 926-4 (respectively) can be recovered based on combining (e.g., multiplying) the set of scalar values from each respective compressed representation 932-2, 932-3, 932-4 with the set of anchor values 925 from the first compressed representation 932-1. For example, the second compressed representation 932-2 comprises the three scalar values [1, 0.5, 0]. The third compressed representation 932-3 comprises the three scalar values [1.1, 0.6, 0]. The fourth compressed representation 932-4 comprises the three scalar values [0, 0.5, 0].

In one illustrative example, the systems and techniques can implement one or more convolution operations using the compressed representations 932-1, 932-2, 932-3, 932-4 of the convolution kernel 920 of FIG. 9, where the convolution can be performed without a decoder or decoding stage to retrieve data and/or convolution kernel filter values. For example, based on the compressed representations 932-1, 932-2, 932-3, 932-4 comprising scalar values, the convolution operations can be performed directly with scalars, without using or needing a separate decoding process or decoding stage. In some aspects, performing the convolution directly using the scalar values from the compressed representations 932-1, 932-2, 932-3, 932-4 of the convolution kernel 920 can correspond to increased performance and power efficiency of a processing system that implements a CNN or other machine learning network that includes the convolution kernel 920 and utilizes the convolution kernel compression based on the inter-kernel correlation 900 of FIG. 9. For example, the increased performance and power efficiency of the processing system implementing the CNN or other machine learning network that includes convolution kernel 920 can be based on using the compressed representation 932-1, 932-2, 932-3, 932-4 to eliminate the need for a separate decoding process to support the convolution operations.

In some examples, a process of network training for implementing the convolution acceleration and compression (e.g., intra-kernel compression and/or inter-kernel compression) can be performed based on obtaining the trained convolution kernels from each of the convolution layers of a convolution-based machine learning network. The trained convolution kernels from each of the convolution layers may comprise a plurality of individual convolution filters. The process can include grouping the trained convolution kernels by layers. After grouping the trained convolution kernels by layers, the process can include determining the linear independence of each vector within the convolution kernel. A scaling factor can be calculated to reproduce a linearly dependent vector from an independent vector. For intra-kernel compression, the linearly independent vector can be stored along with the respective scaling factor for reproducing each linearly dependent vector associated with the identified linearly independent vector. In some aspects, the process can include checking the linear independence between all convolution kernels within a layer, and calculating the scaling factor to reproduce identified linearly dependent vectors from an identified independent vector of a different kernel. For example, for inter-kernel compression, the process can include grouping convolution kernels and storing the linearly independent vector with respective scaling factors calculated for reproducing the identified linearly dependent vectors of different kernels.

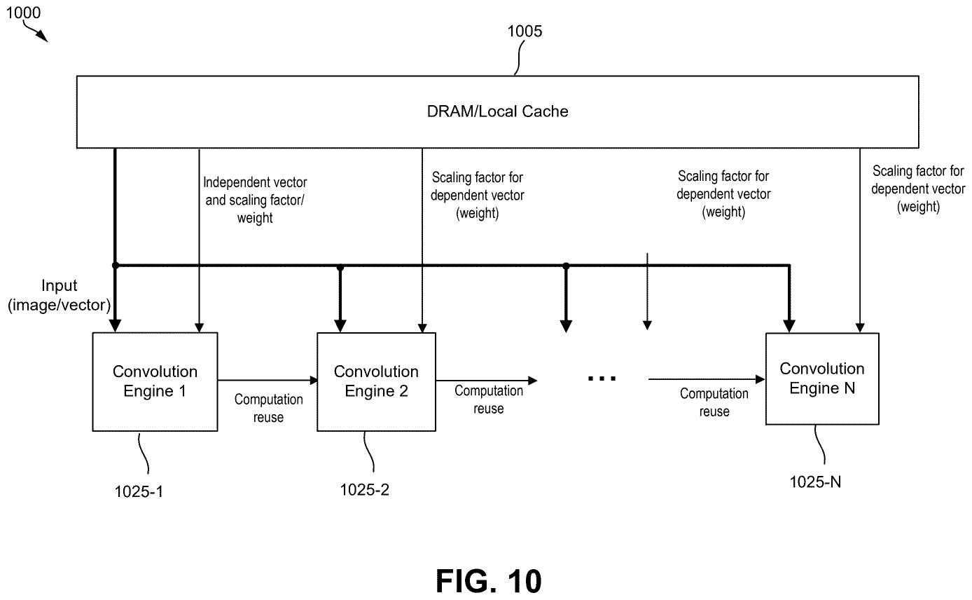

FIG. 10 is a block diagram illustrating an example of a convolution engine 1000 that can be configured to perform convolution based on learned linear independence and computation re-use based on correlations between convolution kernels, in accordance with some examples. In some aspects, the convolution engine 1000 can include a DRAM or local cache 1005 that may be configured to store convolution kernel information, including respective convolution filter weight values for individual convolution filters included in the plurality of convolution filters implemented by a convolution kernel. The convolution engine 1000 can include a plurality of convolution sub-engines, such as the convolution sub-engine 1025-1, the convolution sub-engine 1025-2, . . . , the convolution sub-engine 1025-N. In some aspects, to implement computation re-use and convolution acceleration and/or compression, the convolution engine can provide an input image or vector from the DRAM/local cache 1005 to each respective one of the plurality of N convolution sub-engines 1025-1, 1025-2, . . . , 1025-N. The first convolution sub-engine 1025-1 can obtain and/or determine independent vector and scaling factor or weight information from the DRAM/local cache 1005. For example, the first convolution sub-engine 1025-1 can access the DRAM/local cache 1005 to determine linearly independent vector and weighting information. Between successive convolution sub-engines, computation re-use can be implemented based on one or more of inter-kernel compression and/or intra-kernel compression. For example, the second convolution sub-engine 1025-2 can perform computation re-use based on one or more computations of the first convolution sub-engine 1025-1. The second convolution sub-engine 1025-2 can access the DRAM/local cache 1005 to obtain the input image or vector, and to obtain scaling factor information for weighting the dependent vectors that can be derived from one or more independent vectors corresponding to inter-kernel compression or intra-kernel compression indicated within the computation reuse information provided between the first convolution sub-engine 1025-1 and the second convolution sub-engine 1025-2. Similarly, computation re-use can be performed from the output of the second convolution sub-engine 1025-2 using scaling factor weighting information for deriving dependent vectors, as obtained by a later convolution sub-engine from accessing the DRAM/local cache 1005. The N^{th} convolution sub-engine 1025-N can obtain computation reuse information from the (N−1)^{th} convolution sub-engine, indicative of inter-kernel compression and/or intra-kernel compression for one or more independent vectors included within the output and/or computation reuse information provided form the (N−1)^{th} convolution sub-engine to the N^{th} convolution sub-engine 1025-N. The respective scaling factors for weighting the independent vectors included in the computation reuse information provided as input to the N^{th} convolution sub-engine 1025-N (e.g., the output of the (N−1)^{th} convolution sub-engine) can be obtained by the N^{th} convolution sub-engine 1025-N accessing the DRAM/local cache 1005, and combining the respective scaling factor weights with the corresponding independent vector in order to thereby obtain each respective one of the dependent vectors included in the convolution operations performed by the N^{th} convolution sub-engine 1025-N.

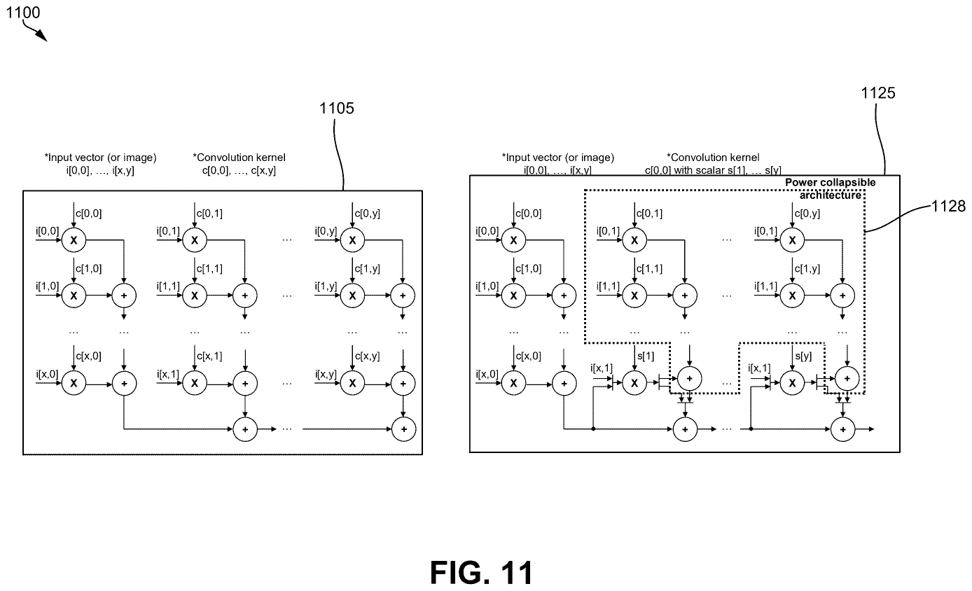

FIG. 11 is a block diagram illustrating an example architecture of a convolution engine 1100 that can be implemented with a power collapsible architecture according to the convolution kernel compression and/or learned linear independence information, in accordance with some examples. For example, a first convolution engine 1105 architecture may correspond to a convolution engine configured to implement convolution without inter-kernel and/or intra-kernel compression, and without a power-collapsible portion of the first convolution engine 1105 architecture. A second convolution engine 1125 architecture may correspond to a convolution engine configured to implement convolution with inter-kernel and/or intra-kernel compression, and including a power-collapsible portion 1128 of the second convolution engine 1125 architecture. In some aspects, the second convolution engine 1125 architecture can be based on modifying the first convolution engine 1105 architecture according to the inter-kernel compression and/or intra-kernel compression implementations for convolution acceleration.

In the example architecture of the first convolution engine 1105, element-wise multiplication and addition is performed between each respective element of the convolution kernel c[0,0], . . . , c[x,y] and each respective pixel location of the input image i[0,0], . . . , i[x,y].

In the example architecture of the second convolution engine 1125, element-wise multiplication and addition is performed between the first column of input image values (e.g., i[0,0], i[1,0], . . . , i[x,0]) and the corresponding first column of convolution kernel values (e.g., c[0,0], c[1,0], . . . , c[x,0]).

The power collapsible portion 1128 of the architecture of the second convolution engine 1125 configured for inter-kernel and/or intra-kernel compression can be skipped (e.g., not used, not powered, etc.) during the convolution operations and computations performed using the second convolution engine 11215 for the input image i[0,0], . . . , i[x,y]. For example, the input to the second convolution engine 1125 can further include a compressed representation of the convolution kernel, according to the scalar weighting values for determining linearly dependent vectors from identified linearly independent vectors based on the inter-kernel and/or intra-kernel compression and correlation information.

For example, the convolution multiplication and addition operations for the second column of the image can be skipped and may be included in the power collapsible architecture section 1128, based on obtaining the convolution output for the second column of the input image using the corresponding scalar weighting factor information s[1], which may be multiplied with i[x,1] and the respective output of the first column convolution operations for i[0,0]*c[0,0]+i[1,0]*c[1,0]+ . . . +i[x,0]*c[x,0]. The output of the scalar weight factor s[1] multiplication for the second column of the input image can be summed with the respective output of the first column convolution operations to obtain the complete convolution output for the second column of the input image. The same process can be repeated for the remaining columns of the input image and the compressed convolution kernel, using the respective scalar weighting factor values for each respective one of the remaining columns. The final column of the input image i[x, 1] can be calculated based on multiplication with the respective scalar weighting factor s[y] used to recover the compressed convolution kernel information as linearly dependent vectors weighted by the scalar factor s[y] applied to a linearly independent vector of the output(s) of the previous convolution operations for the earlier column(s) of the input image. The power collapsible architecture portion 1128 can include the respective multiply and accumulate operations for each of the image and convolution columns between i[0,1]*c[0,1]+i[1,1]*c[1,1]+ . . . , and i[0,1]*c[0,y]+i[1,1]*c[1,y]+ . . . , etc.

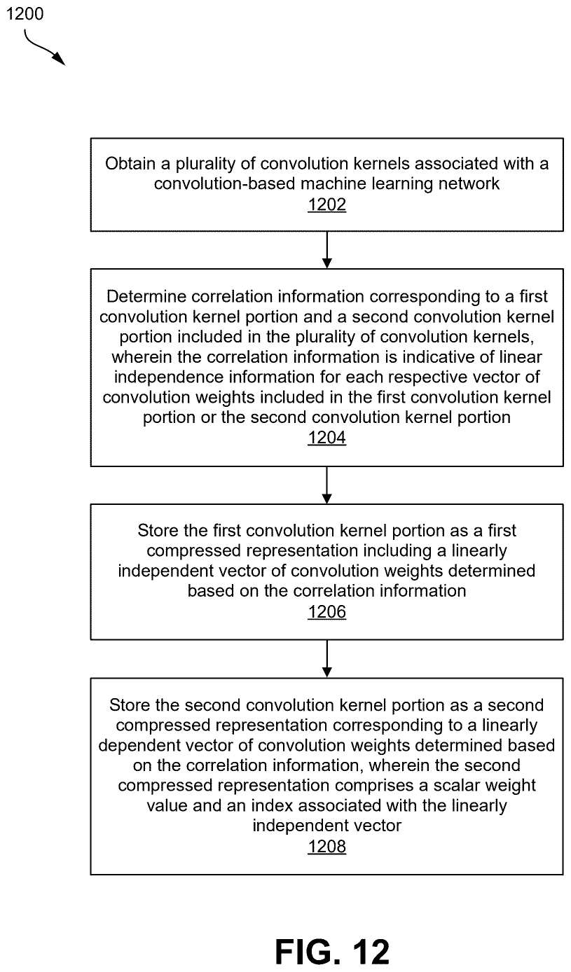

FIG. 12 is a flowchart diagram illustrating an example of a process 1200. Although the example process 1200 depicts a particular sequence of operations, the sequence may be altered without departing from the scope of the present disclosure. For example, some of the operations depicted may be performed in parallel or in a different sequence that does not materially affect the function of the process 1200. In other examples, different components of an example device or system that implements the process 1200 may perform functions at substantially the same time or in a specific sequence.

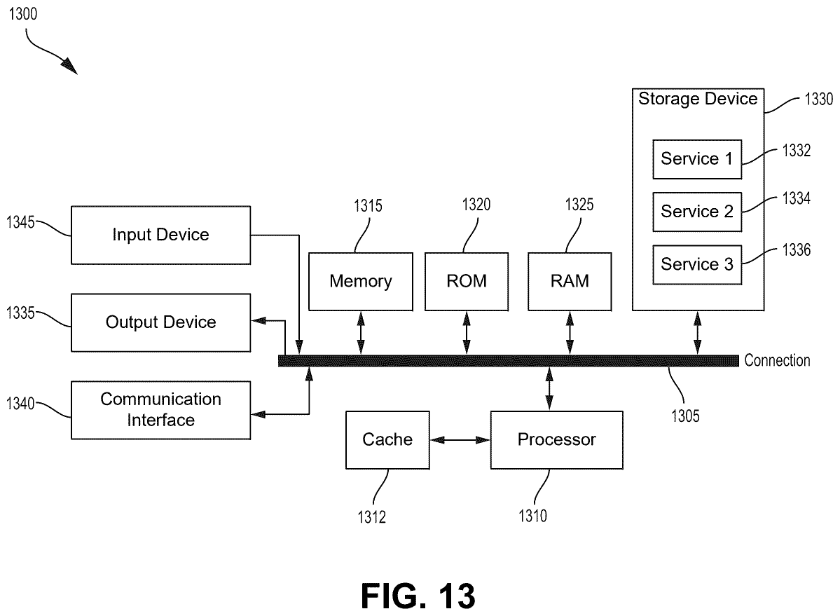

In some examples, the process 1200 can be performed by a computing device or apparatus or a component or system (e.g., one or more chipsets, one or more processors such as one or more CPUs, DSPs, NPUs, NSPs, microcontrollers, ASICs, FPGAs, programmable logic devices, discrete gates or transistor logic components, discrete hardware components, etc., any combination thereof, and/or other component or system) of the computing device or apparatus. The operations of the process 1200 may be implemented as software components that are executed and run on one or more processors (e.g., processor 1310 of FIG. 13 or other processor(s)). In some examples, the process 1200 can be performed by a machine learning network, including any of the machine learning networks and/or neural networks described herein, etc. For example, the process 1200 can be performed by the convolution engine 1000 of FIG. 10, one or more of the convolution sub-engines 1025-1, . . . , 1025-N of FIG. 10, the convolution engine architecture 1125 of FIG. 11, etc.

In some aspects, the process 1200 can be performed by a UE, smartphone, mobile computing device, user computing device, etc. The process 1200 may be performed by an apparatus that may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1200 may be implemented as software components that are executed and run on one or more processors (e.g., processor 1310 of FIG. 13, and/or other processor(s)).

At block 1202, the apparatus (or component thereof) can obtain a plurality of convolution kernels associated with a convolution-based machine learning network. For example, the convolution-based machine learning network can be a CNN and/or can be a machine learning network implementing one or more portions or components of the various machine learning architectures and systems of FIGS. 1-11. In some cases, the plurality of convolution kernels can correspond to the convolution kernel 620-1, 620-2, . . . , 620-9 of FIG. 6. In some cases, the plurality of convolution kernels can correspond to the convolution kernel 720 of FIG. 7, 812-1, 812-2, 812-3 of FIG. 8, 820 of FIG. 8, 920 of FIG. 9, etc.

At block 1204, the apparatus (or component thereof) can determine correlation information corresponding to a first convolution kernel portion and a second convolution kernel portion included in the plurality of convolution kernels, wherein the correlation information is indicative of linear independence information for each respective vector of convolution weights included in the first convolution kernel portion or the second convolution kernel portion.

For example, the correlation information can correspond to the example intra-kernel compression 800 of FIG. 8, where the first and second convolution kernel portions are included within the same convolution kernel (e.g., included within the same convolution kernel 820 of FIG. 8, etc.). In some cases, the correlation information can correspond to the example inter-kernel correlation 900 of FIG. 9, where the first and second convolution kernel portions are included within different convolution kernels (e.g., the different convolution kernels 924-1, 924-2, 924-3, 924-4, etc., of FIG. 9).

In some cases, the correlation information comprises intra-kernel correlation information corresponding to a particular convolution kernel of the plurality of convolution kernels. For example, the first convolution kernel portion can correspond to a first window position of the particular convolution kernel applied to an input image, such as the input image 702 of FIG. 7, 802 of FIG. 8, etc. The second convolution kernel portion can correspond to a second window position of the particular convolution kernel applied to the input image.

In some cases, the first and second window positions are respective sliding window positions associated with convolution using the particular convolution kernel, where the correlation information is indicative of an overlap between the first and second window positions. For example, the first and second window positions can be selected from among the first window position 812-1, second window position 812-2, third window position 812-3, etc., of the intra-kernel compression 800 of FIG. 8. In some examples, the second compressed representation is indicative of the scalar weight value between applying the particular convolution kernel within the first window position and applying the particular convolution kernel within the second window position.

In some cases, the apparatus (or component thereof) can be configured to determine the subset of convolution kernels based on similarity information corresponding to the respective convolution kernels of the subset of convolution kernels. For example, the first convolution kernel portion can comprise a first convolution kernel included in the subset of convolution kernels, and the second convolution kernel portion can comprise a second convolution kernel included in the subset of convolution kernels.

At block 1206, the apparatus (or component thereof) can store the first convolution kernel portion as a first compressed representation including a linearly independent vector of convolution weights determined based on the correlation information. In some cases, the index associated with the linearly independent vector is indicative of a memory location used to store one or more of the first compressed representation or the linearly independent vector of convolution weights.

In some examples, the correlation information can comprise inter-kernel correlation information corresponding to one or more overlaps between respective convolution kernels of a subset of convolution kernels included in the plurality of convolution kernels. For example, the correlation information can comprise inter-kernel correlation information corresponding to the example inter-kernel correlation example 900 of FIG. 9.

In some cases, wherein the linearly independent vector of convolution weights included in the first compressed representation comprises an anchor portion of convolution weights. For example, the first compressed representation can be the first compressed representation 932-1 of FIG. 9, and the linearly independent vector of convolution weights can comprise the anchor portion 925 of FIG. 9. In some examples, one or more columns or rows of additional convolution kernels of the subset of convolution kernels are scalar multiples of the anchor portion of convolution weights. For example, one or more columns or rows of the additional convolution kernels 926-2, 926-3, 926-4 are scalar multiples of the anchor portion 925 of FIG. 9.

At block 1208, the apparatus (or component thereof) can store the second convolution kernel portion as a second compressed representation corresponding to a linearly dependent vector of convolution weights determined based on the correlation information, wherein the second compressed representation comprises a scalar weight value and an index associated with the linearly independent vector.

In some cases, the linearly dependent vector of convolution weights included in the second compressed representation is a scalar multiple of the linearly independent vector of convolution weights included in the first compressed representation. In some examples, the scalar weight value is equal to the scalar multiple.

In some examples, the second compressed representation includes a plurality of scalar weight values. For example, the second compressed representation can correspond to one or more of the compressed representation 932-2 of FIG. 9 (e.g., including the scalar weight values [1, 0.5, 0]), the compressed representation 932-3 of FIG. 9 (e.g., including the scalar weight values [1.1, 0.6, 0]), and/or the compressed representation 932-4 of FIG. 9 (e.g., including the scalar weight values [0, 0.5, 0]), etc.

In some cases, the plurality of scalar weight values includes a respective scalar weight value for each linearly dependent vector of convolution weights included in the second convolution kernel. In some examples each linearly dependent vector of convolution weights included in the second convolution kernel is equal to the linearly independent vector of convolution weights included in the first convolution kernel multiplied with the respective scalar weight value for each linearly dependent vector. In some cases, each linearly dependent vector of convolution weights included in the second convolution kernel comprises a respective row of the second convolution kernel or a respective column of the second convolution kernel.

FIG. 13 illustrates an example computing device architecture 1300 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. The components of computing device architecture 1300 are shown in electrical communication with each other using connection 1305, such as a bus. The example computing device architecture 1300 includes a processing unit (CPU or processor) 1310 and computing device connection 1305 that couples various computing device components including computing device memory 1315, such as read only memory (ROM) 1320 and random access memory (RAM) 1325, to processor 1310.

Computing device architecture 1300 can include a cache of high-speed memory connected directly with, in close proximity to, or integrated as part of processor 1310. Computing device architecture 1300 can copy data from memory 1315 and/or the storage device 1330 to cache 1312 for quick access by processor 1310. In this way, the cache can provide a performance boost that avoids processor 1310 delays while waiting for data. These and other modules can control or be configured to control processor 1310 to perform various actions. Other computing device memory 1315 may be available for use as well. Memory 1315 can include multiple different types of memory with different performance characteristics. Processor 1310 can include any general purpose processor and a hardware or software service, such as service 1 1332, service 2 1334, and service 3 1336 stored in storage device 1330, configured to control processor 1310 as well as a special-purpose processor where software instructions are incorporated into the processor design. Processor 1310 may be a self-contained system, containing multiple cores or processors, a bus, memory controller, cache, etc. A multi-core processor may be symmetric or asymmetric.

To enable user interaction with the computing device architecture 1300, input device 1345 can represent any number of input mechanisms, such as a microphone for speech, a touch-sensitive screen for gesture or graphical input, keyboard, mouse, motion input, speech and so forth. Output device 1335 can also be one or more of a number of output mechanisms known to those of skill in the art, such as a display, projector, television, speaker device, etc. In some instances, multimodal computing devices can enable a user to provide multiple types of input to communicate with computing device architecture 1300. Communication interface 1340 can generally govern and manage the user input and computing device output. There is no restriction on operating on any particular hardware arrangement and therefore the basic features here may easily be substituted for improved hardware or firmware arrangements as they are developed.

Storage device 1330 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1325, read only memory (ROM) 1320, and hybrids thereof. Storage device 1330 can include services 1332, 1334, 1336 for controlling processor 1310. Other hardware or software modules are contemplated. Storage device 1330 can be connected to the computing device connection 1305. In some aspects, a hardware module that performs a particular function can include the software component stored in a computer-readable medium in connection with the necessary hardware components, such as processor 1310, connection 1305, output device 1335, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for processing image data, comprising: at least one memory; and at least one processor coupled to the at least one memory, the at least one processor configured to: obtain a plurality of convolution kernels associated with a convolution-based machine learning network; determine correlation information corresponding to a first convolution kernel portion and a second convolution kernel portion included in the plurality of convolution kernels, wherein the correlation information is indicative of linear independence information for each respective vector of convolution weights included in the first convolution kernel portion or the second convolution kernel portion; store the first convolution kernel portion as a first compressed representation including a linearly independent vector of convolution weights determined based on the correlation information; and store the second convolution kernel portion as a second compressed representation corresponding to a linearly dependent vector of convolution weights determined based on the correlation information, wherein the second compressed representation comprises a scalar weight value and an index associated with the linearly independent vector.

Aspect 2. The apparatus of Aspect 1, wherein the linearly dependent vector of convolution weights included in the second compressed representation is a scalar multiple of the linearly independent vector of convolution weights included in the first compressed representation.

Aspect 3. The apparatus of Aspect 2, wherein the scalar weight value is equal to the scalar multiple.

Aspect 4. The apparatus of any of Aspects 1 to 3, wherein the index associated with the linearly independent vector is indicative of a memory location used to store one or more of the first compressed representation or the linearly independent vector of convolution weights.

Aspect 5. The apparatus of any of Aspects 1 to 4, wherein the correlation information comprises intra-kernel correlation information corresponding to a particular convolution kernel of the plurality of convolution kernels.

Aspect 6. The apparatus of Aspect 5, wherein the first convolution kernel portion corresponds to a first window position of the particular convolution kernel applied to an input image, and wherein the second convolution kernel portion corresponds to a second window position of the particular convolution kernel applied to the input image.

Aspect 7. The apparatus of Aspect 6, wherein the first and second window positions are respective sliding window positions associated with convolution using the particular convolution kernel, and wherein the correlation information is indicative of an overlap between the first and second window positions.

Aspect 8. The apparatus of Aspect 7, wherein the second compressed representation is indicative of the scalar weight value between applying the particular convolution kernel within the first window position and applying the particular convolution kernel within the second window position.

Aspect 9. The apparatus of any of Aspects 1 to 8, wherein the correlation information comprises inter-kernel correlation information corresponding to one or more overlaps between respective convolution kernels of a subset of convolution kernels included in the plurality of convolution kernels.

Aspect 10. The apparatus of Aspect 9, wherein the at least one processor is further configured to determine the subset of convolution kernels based on similarity information corresponding to the respective convolution kernels of the subset of convolution kernels.

Aspect 11. The apparatus of any of Aspects 9 to 10, wherein the first convolution kernel portion comprises a first convolution kernel included in the subset of convolution kernels, and wherein the second convolution kernel portion comprises a second convolution kernel included in the subset of convolution kernels.

Aspect 12. The apparatus of Aspect 11, wherein the second compressed representation includes a plurality of scalar weight values.

Aspect 13. The apparatus of Aspect 12, wherein the plurality of scalar weight values includes a respective scalar weight value for each linearly dependent vector of convolution weights included in the second convolution kernel.

Aspect 14. The apparatus of Aspect 13, wherein each linearly dependent vector of convolution weights included in the second convolution kernel is equal to the linearly independent vector of convolution weights included in the first convolution kernel multiplied with the respective scalar weight value for each linearly dependent vector.

Aspect 15. The apparatus of any of Aspects 13 to 14, wherein each linearly dependent vector of convolution weights included in the second convolution kernel comprises a respective row of the second convolution kernel or a respective column of the second convolution kernel.

Aspect 16. The apparatus of any of Aspects 9 to 15, wherein the linearly independent vector of convolution weights included in the first compressed representation comprises an anchor portion of convolution weights, and wherein one or more columns or rows of additional convolution kernels of the subset of convolution kernels are scalar multiples of the anchor portion of convolution weights.

Aspect 17. A method comprising: obtaining a plurality of convolution kernels associated with a convolution-based machine learning network; determining correlation information corresponding to a first convolution kernel portion and a second convolution kernel portion included in the plurality of convolution kernels, wherein the correlation information is indicative of linear independence information for each respective vector of convolution weights included in the first convolution kernel portion or the second convolution kernel portion; storing the first convolution kernel portion as a first compressed representation including a linearly independent vector of convolution weights determined based on the correlation information; and storing the second convolution kernel portion as a second compressed representation corresponding to a linearly dependent vector of convolution weights determined based on the correlation information, wherein the second compressed representation comprises a scalar weight value and an index associated with the linearly independent vector.

Aspect 18. The method of Aspect 17, wherein the linearly dependent vector of convolution weights included in the second compressed representation is a scalar multiple of the linearly independent vector of convolution weights included in the first compressed representation.

Aspect 19. The method of Aspect 18, wherein the scalar weight value is equal to the scalar multiple.

Aspect 20. The method of any of Aspects 17 to 19, wherein the index associated with the linearly independent vector is indicative of a memory location used to store one or more of the first compressed representation or the linearly independent vector of convolution weights.

Aspect 21. The method of any of Aspects 17 to 20, wherein the correlation information comprises intra-kernel correlation information corresponding to a particular convolution kernel of the plurality of convolution kernels.

Aspect 22. The method of Aspect 21, wherein the first convolution kernel portion corresponds to a first window position of the particular convolution kernel applied to an input image, and wherein the second convolution kernel portion corresponds to a second window position of the particular convolution kernel applied to the input image.

Aspect 23. The method of Aspect 22, wherein the first and second window positions are respective sliding window positions associated with convolution using the particular convolution kernel, and wherein the correlation information is indicative of an overlap between the first and second window positions.

Aspect 24. The method of Aspect 23, wherein the second compressed representation is indicative of the scalar weight value between applying the particular convolution kernel within the first window position and applying the particular convolution kernel within the second window position.

Aspect 25. The method of any of Aspects 17 to 24, wherein the correlation information comprises inter-kernel correlation information corresponding to one or more overlaps between respective convolution kernels of a subset of convolution kernels included in the plurality of convolution kernels.

Aspect 26. The method of Aspect 25, further comprising determining the subset of convolution kernels based on similarity information corresponding to the respective convolution kernels of the subset of convolution kernels.

Aspect 27. The method of any of Aspects 25 to 26, wherein the first convolution kernel portion comprises a first convolution kernel included in the subset of convolution kernels, and wherein the second convolution kernel portion comprises a second convolution kernel included in the subset of convolution kernels.

Aspect 28. The method of Aspect 27, wherein the second compressed representation includes a plurality of scalar weight values.

Aspect 29. The method of Aspect 28, wherein the plurality of scalar weight values includes a respective scalar weight value for each linearly dependent vector of convolution weights included in the second convolution kernel.

Aspect 30. The method of Aspect 29, wherein each linearly dependent vector of convolution weights included in the second convolution kernel is equal to the linearly independent vector of convolution weights included in the first convolution kernel multiplied with the respective scalar weight value for each linearly dependent vector.

Aspect 31. The method of any of Aspects 29 to 30, wherein each linearly dependent vector of convolution weights included in the second convolution kernel comprises a respective row of the second convolution kernel or a respective column of the second convolution kernel.

Aspect 32. The method of any of Aspects 25 to 31, wherein the linearly independent vector of convolution weights included in the first compressed representation comprises an anchor portion of convolution weights, and wherein one or more columns or rows of additional convolution kernels of the subset of convolution kernels are scalar multiples of the anchor portion of convolution weights.

Aspect 33. A non-transitory computer-readable medium including instructions that, when executed by at least one processor, cause the at least one processor to: obtain a plurality of convolution kernels associated with a convolution-based machine learning network; determine correlation information corresponding to a first convolution kernel portion and a second convolution kernel portion included in the plurality of convolution kernels, wherein the correlation information is indicative of linear independence information for each respective vector of convolution weights included in the first convolution kernel portion or the second convolution kernel portion; store the first convolution kernel portion as a first compressed representation including a linearly independent vector of convolution weights determined based on the correlation information; and store the second convolution kernel portion as a second compressed representation corresponding to a linearly dependent vector of convolution weights determined based on the correlation information, wherein the second compressed representation comprises a scalar weight value and an index associated with the linearly independent vector.

Aspect 34. The non-transitory computer-readable medium of Aspect 33, wherein the linearly dependent vector of convolution weights included in the second compressed representation is a scalar multiple of the linearly independent vector of convolution weights included in the first compressed representation.

Aspect 35. The non-transitory computer-readable medium of Aspect 34, wherein the scalar weight value is equal to the scalar multiple.

Aspect 36. The non-transitory computer-readable medium of any of Aspects 33 to 35, wherein the index associated with the linearly independent vector is indicative of a memory location used to store one or more of the first compressed representation or the linearly independent vector of convolution weights.

Aspect 37. The non-transitory computer-readable medium of any of Aspects 33 to 36, wherein the correlation information comprises intra-kernel correlation information corresponding to a particular convolution kernel of the plurality of convolution kernels.

Aspect 38. The non-transitory computer-readable medium of Aspect 37, wherein the first convolution kernel portion corresponds to a first window position of the particular convolution kernel applied to an input image, and wherein the second convolution kernel portion corresponds to a second window position of the particular convolution kernel applied to the input image.

Aspect 39. The non-transitory computer-readable medium of Aspect 38, wherein the first and second window positions are respective sliding window positions associated with convolution using the particular convolution kernel, and wherein the correlation information is indicative of an overlap between the first and second window positions.

Aspect 40. The non-transitory computer-readable medium of Aspect 39, wherein the second compressed representation is indicative of the scalar weight value between applying the particular convolution kernel within the first window position and applying the particular convolution kernel within the second window position.

Aspect 41. The non-transitory computer-readable medium of any of Aspects 33 to 40, wherein the correlation information comprises inter-kernel correlation information corresponding to one or more overlaps between respective convolution kernels of a subset of convolution kernels included in the plurality of convolution kernels.

Aspect 42. The non-transitory computer-readable medium of Aspect 41, wherein the at least one processor is further configured to determine the subset of convolution kernels based on similarity information corresponding to the respective convolution kernels of the subset of convolution kernels.

Aspect 43. The non-transitory computer-readable medium of any of Aspects 41 to 42, wherein the first convolution kernel portion comprises a first convolution kernel included in the subset of convolution kernels, and wherein the second convolution kernel portion comprises a second convolution kernel included in the subset of convolution kernels.

Aspect 44. The non-transitory computer-readable medium of Aspect 43, wherein the second compressed representation includes a plurality of scalar weight values.

Aspect 45. The non-transitory computer-readable medium of Aspect 44, wherein the plurality of scalar weight values includes a respective scalar weight value for each linearly dependent vector of convolution weights included in the second convolution kernel.

Aspect 46. The non-transitory computer-readable medium of Aspect 45, wherein each linearly dependent vector of convolution weights included in the second convolution kernel is equal to the linearly independent vector of convolution weights included in the first convolution kernel multiplied with the respective scalar weight value for each linearly dependent vector.

Aspect 47. The non-transitory computer-readable medium of any of Aspects 45 to 46, wherein each linearly dependent vector of convolution weights included in the second convolution kernel comprises a respective row of the second convolution kernel or a respective column of the second convolution kernel.

Aspect 48. The non-transitory computer-readable medium of any of Aspects 41 to 47, wherein the linearly independent vector of convolution weights included in the first compressed representation comprises an anchor portion of convolution weights, and wherein one or more columns or rows of additional convolution kernels of the subset of convolution kernels are scalar multiples of the anchor portion of convolution weights.

Aspect 49. A non-transitory computer-readable storage medium comprising instructions stored thereon which, when executed by at least one processor, causes the at least one processor to perform operations according to any of Aspects 1 to 16.

Aspect 50. A non-transitory computer-readable storage medium comprising instructions stored thereon which, when executed by at least one processor, causes the at least one processor to perform operations according to any of Aspects 17 to 32.

Aspect 51. An apparatus comprising one or more means for performing operations according to any of Aspects 1 to 16.

Aspect 52. An apparatus comprising one or more means for performing operations according to any of Aspects 17 to 32.

Aspect 53. An apparatus comprising one or more means for performing operations according to any of Aspects 33 to 48.

Aspect 54. A method comprising performing operations according to any of Aspects 1 to 16.

Aspect 55. A method comprising performing operations according to any of Aspects 33 to 48.

What is claimed is:

1. An apparatus for processing image data, comprising:
at least one memory; and
at least one processor coupled to the at least one memory, the at least one processor configured to:
obtain a plurality of convolution kernels associated with a convolution-based machine learning network;
determine correlation information corresponding to a first convolution kernel portion and a second convolution kernel portion included in the plurality of convolution kernels, wherein the correlation information is indicative of linear independence information for each respective vector of convolution weights included in the first convolution kernel portion or the second convolution kernel portion;
store the first convolution kernel portion as a first compressed representation including a linearly independent vector of convolution weights determined based on the correlation information; and
store the second convolution kernel portion as a second compressed representation corresponding to a linearly dependent vector of convolution weights determined based on the correlation information, wherein the second compressed representation comprises a scalar weight value and an index associated with the linearly independent vector.

2. The apparatus of claim 1, wherein the linearly dependent vector of convolution weights included in the second compressed representation is a scalar multiple of the linearly independent vector of convolution weights included in the first compressed representation.

3. The apparatus of claim 2, wherein the scalar weight value is equal to the scalar multiple.

4. The apparatus of claim 1, wherein the index associated with the linearly independent vector is indicative of a memory location used to store one or more of the first compressed representation or the linearly independent vector of convolution weights.

5. The apparatus of claim 1, wherein the correlation information comprises intra-kernel correlation information corresponding to a particular convolution kernel of the plurality of convolution kernels.

6. The apparatus of claim 5, wherein the first convolution kernel portion corresponds to a first window position of the particular convolution kernel applied to an input image, and wherein the second convolution kernel portion corresponds to a second window position of the particular convolution kernel applied to the input image.

7. The apparatus of claim 6, wherein the first and second window positions are respective sliding window positions associated with convolution using the particular convolution kernel, and wherein the correlation information is indicative of an overlap between the first and second window positions.

8. The apparatus of claim 7, wherein the second compressed representation is indicative of the scalar weight value between applying the particular convolution kernel within the first window position and applying the particular convolution kernel within the second window position.

9. The apparatus of claim 1, wherein the correlation information comprises inter-kernel correlation information corresponding to one or more overlaps between respective convolution kernels of a subset of convolution kernels included in the plurality of convolution kernels.

10. The apparatus of claim 9, wherein the at least one processor is further configured to determine the subset of convolution kernels based on similarity information corresponding to the respective convolution kernels of the subset of convolution kernels.

11. The apparatus of claim 9, wherein the first convolution kernel portion comprises a first convolution kernel included in the subset of convolution kernels, and wherein the second convolution kernel portion comprises a second convolution kernel included in the subset of convolution kernels.

12. The apparatus of claim 11, wherein the second compressed representation includes a plurality of scalar weight values.

13. The apparatus of claim 12, wherein the plurality of scalar weight values includes a respective scalar weight value for each linearly dependent vector of convolution weights included in the second convolution kernel.

14. The apparatus of claim 13, wherein each linearly dependent vector of convolution weights included in the second convolution kernel is equal to the linearly independent vector of convolution weights included in the first convolution kernel multiplied with the respective scalar weight value for each linearly dependent vector.

15. The apparatus of claim 13, wherein each linearly dependent vector of convolution weights included in the second convolution kernel comprises a respective row of the second convolution kernel or a respective column of the second convolution kernel.

16. The apparatus of claim 9, wherein the linearly independent vector of convolution weights included in the first compressed representation comprises an anchor portion of convolution weights, and wherein one or more columns or rows of additional convolution kernels of the subset of convolution kernels are scalar multiples of the anchor portion of convolution weights.

17. A method comprising:
obtaining a plurality of convolution kernels associated with a convolution-based machine learning network;
determining correlation information corresponding to a first convolution kernel portion and a second convolution kernel portion included in the plurality of convolution kernels, wherein the correlation information is indicative of linear independence information for each respective vector of convolution weights included in the first convolution kernel portion or the second convolution kernel portion;
storing the first convolution kernel portion as a first compressed representation including a linearly independent vector of convolution weights determined based on the correlation information; and
storing the second convolution kernel portion as a second compressed representation corresponding to a linearly dependent vector of convolution weights determined based on the correlation information, wherein the second compressed representation comprises a scalar weight value and an index associated with the linearly independent vector.

18. The method of claim 17, wherein the linearly dependent vector of convolution weights included in the second compressed representation is a scalar multiple of the linearly independent vector of convolution weights included in the first compressed representation.

19. The method of claim 18, wherein the scalar weight value is equal to the scalar multiple.

20. A non-transitory computer-readable medium including instructions that, when executed by at least one processor, cause the at least one processor to:
obtain a plurality of convolution kernels associated with a convolution-based machine learning network;
determine correlation information corresponding to a first convolution kernel portion and a second convolution kernel portion included in the plurality of convolution kernels, wherein the correlation information is indicative of linear independence information for each respective vector of convolution weights included in the first convolution kernel portion or the second convolution kernel portion;
store the first convolution kernel portion as a first compressed representation including a linearly independent vector of convolution weights determined based on the correlation information; and
store the second convolution kernel portion as a second compressed representation corresponding to a linearly dependent vector of convolution weights determined based on the correlation information, wherein the second compressed representation comprises a scalar weight value and an index associated with the linearly independent vector.
